(19) United States
(12) Patent Application Publication
(10) Pub. No.: US 2022/0067617 A1
(43) Pub. Date: Mar. 3, 2022

(54) System and Method for Reducing Choke Points Associated with Switching Between Transportation Modes of a Multi-Modal Transportation Service

(71) Applicant: Joby Elevate, Inc., Santa Cruz, CA (US)

(72) Inventor: Ian Andreas Villa, San Francisco, CA (US)

(21) Appl. No.: 17/465,421

(22) Filed: Sep. 2, 2021

Related U.S. Application Data
(60) Provisional application No. 63/073,608, filed on Sep. 2, 2020.

(51) Int. Cl. G06Q 10/06; G07C 9/00; G06Q 50/26; G06Q 50/14; G05B 15/02; G01C 21/20

(52) U.S. Cl. CPC G06Q 10/06315; G07C 9/00; G06Q 50/265; G06Q 2240/00; G05B 15/02; G01C 21/20; G06Q 50/14

(57) ABSTRACT

A computing system configured to perform operations is provided. The operation operations include obtaining multi-modal transportation data associated with a multi-modal transportation service. The multi-modal transportation data includes user data indicative of a multi-modal transportation itinerary for a user. The operations include obtaining facility data associated with an aerial transport facility. The facility data is indicative of parameters associated with each of a plurality of transition points at the aerial transport facility. The operations include determining one of the plurality of transition points as a selected transition point for the user based, at least in part, on the multi-modal transportation data and the facility data. The operations further include communicating one or more command signals associated with controlling operation of the selected transition point for the user.

### RELATED APPLICATION

The present disclosure is based on and claims priority to U.S. Provisional Application 63/073,608 having a filing date of Sep. 2, 2020, which is incorporated by reference herein.

### FIELD

The present disclosure relates generally to multi-modal transportation services.

### BACKGROUND

A wide variety of modes of transport are available within cities. For example, people can walk, ride a bike, drive a car, take public transit, or use a ride sharing service. However, as population densities and demand for land increase, many cities are experiencing problems with traffic congestion and the associated pollution. Consequently, there is a need to expand the available modes of transport in ways that can reduce the amount of traffic without requiring the use of large amounts of land.

Air travel within cities can reduce travel time over purely ground-based approaches and alleviate problems associated with traffic congestion. Vertical takeoff and landing (VTOL) aircraft provide opportunities to incorporate aerial transportation into transport networks for cities and metropolitan areas. VTOL aircraft require much less space to take-off and land than other types of aircraft, making them more suitable for densely populated urban environments.

### SUMMARY

Aspects and advantages of embodiments of the present disclosure will be set forth in part in the following description, or may be learned from the description, or may be learned through practice of the embodiments.

One example aspect according to the present disclosure is directed to a computer-implemented method. The method includes obtaining, via one or more computing devices of a computing system, multi-modal transportation data associated with a multi-modal transportation service, the multi-modal transportation data including user data indicative of a multi-modal itinerary for a user of the multi-modal transportation service. The method includes obtaining, via the one or more computing devices, facility data associated with an aerial transport facility. The facility data is indicative of parameters associated with each of a plurality of transition points at the aerial transport facility. The method includes determining, via the one or more computing devices, one of the plurality of transition points as a selected transition for the user based, at least in part, on the multi-modal transportation data and the facility data. The method includes communicating, via the one or more computing devices, one or more command signals associated with controlling operation of the selected transition point for the user.

Another example aspect according to the present disclosure is directed to one or more tangible, non-transitory computer-readable media storing computer-readable instructions that, when executed by one or more processors, cause the one or more processors to perform operations. The operations include obtaining multi-modal transportation data associated with a multi-modal transportation service, the multi-modal transportation data including user data indicative of a multi-modal itinerary for a user of the multi-modal transportation service. The operations include obtaining facility data associated with an aerial transport facility. The facility data is indicative of parameters associated with each of a plurality of transition points at the aerial transport facility. The operations include determining one of the plurality of transition points as a selected transition point for the user based, at least in part, on the multi-modal transportation data and the facility data. The operations include communicating one or more command signals associated with controlling operation of the selected transition point for the user.

Yet another example aspect according to the present disclosure is directed to a computing system. The computing system includes one or more processors and one or more tangible, non-transitory computer-readable media storing computer-readable instructions that, when executed by one or more processors, cause the one or more processors to perform operations. The operations include obtaining multi-modal transportation data associated with a multi-modal transportation service, the multi-modal transportation data including user data indicative of a multi-modal itinerary for a user of the multi-modal transportation service. The operations include obtaining facility data associated with an aerial transport facility. The facility data is indicative of parameters associated with each of a plurality of transition points at the aerial transport facility. The operations include determining one of the plurality of elevators as a selected transition point for the user based, at least in part, on the multi-modal transportation data and the facility data. The operations include communicating one or more command signals associated with controlling operation of the selected transition point for the user.

Other example aspects of the present disclosure are directed to other systems, methods, vehicles, apparatuses, tangible non-transitory computer-readable media, and devices for reducing choke points associated with switching between transportation modes of a multi-modal transportation service.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing system according to example embodiments of the present disclosure.

FIG. 2 depicts a perspective view of an aerial transport facility according to example embodiments of the present disclosure.

FIG. 3 depicts a multi-modal transportation service according to example embodiments of the present disclosure.

FIG. 4 depicts elevators at a first aerial transport facility and a second aerial transport facility according to example embodiments of the present disclosure.

FIG. 5 depicts a block diagram of components of a transition point according to example embodiments of the present disclosure.

FIG. 6 depicts a flowchart of a method for selecting a transition point at an aerial transport facility for a user of a multi-modal transportation service according to example embodiments of the present disclosure.

FIG. 7 depicts a flow chart of a method for selecting a transition point at an aerial transport facility for a user according to example embodiments of the present disclosure.

FIG. 8 depicts a flow chart of a method for selecting a transition point at an aerial transport facility for a user of a multi-modal transportation service according to example embodiments of the present disclosure.

FIG. 9 depicts a flow chart of a method for selecting a transition point at an aerial transport facility for a user of a multi-modal transportation service according to example embodiments of the present disclosure.

FIG. 10 depicts a block diagram of an example computing system according to example embodiments of the present disclosure.

### DETAILED DESCRIPTION

Example aspects of the present disclosure are directed to systems and methods for reducing choke points associated with switching between modalities (e.g., ground-based transportation service and aerial-based transportation service) of a multi-modal transportation service. For instance, at certain facilities, users of the multi-modal transportation service must utilize one of a plurality of transition points at an aerial transport facility when switching between a ground-based transportation service and an aerial-based transportation service, or vice versa. The transition point(s) can include, for example, at least one of: one or more points of ingress (e.g., entrance passageway, gate, ramps, etc.), one or more elevators and/or other facility transport mechanisms, or one or more points of egress (e.g., exits, etc.), and/or a combination thereof. In some implementations, transition point(s) can be associated with designated areas/portion of the aerial facility. By way of example, elevators can be transition points. The elevators at the aerial transport facility can be a chokepoint for the users, because the elevators may also be used by persons that live or work at the aerial transport facility. For example, instances can occur in which all of the elevators are occupied when one or more users of the multi-modal transportation service arrive at the aerial transportation facility to switch between the ground-based transportation service and the aerial-based transportation service. In such instances, the one or more users of the multi-modal transportation service may wait until one of the elevators becomes available. This delay can represent a choke point associated with switching between the ground-based transportation service and the aerial-based transportation service.

As another example, at certain facilities, users of the multi-modal transportation service must pass through at least one point of ingress or egress (e.g., door, hallway, exit, etc.) at an aerial transport facility when switching between an aerial-based transportation service and a ground-based transportation service, or vice versa. The point of ingress or egress at the aerial transport facility can be a chokepoint for the users because the users may be unaware of which point of ingress or egress is the correct point to pass through. For example, if the users pass through the incorrect point of ingress or egress the users both waste time and create unnecessary traffic by passing though the point of ingress or egress the first time as well as when passing through again to retrace their incorrect steps. In such instances, the users may also clog space prior to moving towards a point of ingress or egress while trying to determine which point of ingress or egress is the correct one. This delay can represent a choke point associated with switching between the different modes of transportation service.

A service entity can manage and coordinate a plurality of different types of vehicles to provide the multi-modal transportation service to a plurality of users. For instance, a user can generate a service request for transportation from an origin location to a destination location via an application running on a device (e.g., smartphone, tablet, etc.) associated with the user. A computing system associated with the service entity (e.g., a cloud-based operations computing system, etc.) can obtain data indicative of the service request. The computing system can generate one or more itineraries (e.g., user itinerary, flight itinerary, etc.) based, at least in part, on the data indicative of the service request to facilitate transporting the user from the origin location to the destination location. In some implementations, the vehicles utilized for transporting the user in accordance with an itinerary can be provided by a vehicle provider. This can include, for example, an aerial vehicle provider of aerial vehicles that can be utilized by the service entity (e.g., a transportation platform thereof) for the provision of transportation services for at least a portion of the itinerary.

A user itinerary can be a multi-modal transportation itinerary that includes at least two types of transportation services (e.g., ground based transportation and aerial-based transportation). The multi-modal transportation itinerary can include at least a first leg and a second leg. The first leg can include a ground-based transportation service to transport the user from the origin location (e.g., home) to a first aerial transport facility. The second leg can include an aerial-based transportation service to transport the user from the first aerial transport facility to a second aerial transport facility.

In some implementations, the destination location can be a location other than the second aerial transport facility. In such implementations, the multi-modal transportation itinerary can include a third leg associated with transporting the user from the second aerial transport facility to the destination location. For example, the third leg can include a ground-based transportation service (e.g., car, scooter, train, boat, etc.). Alternatively, the third leg can include an aerial-based transportation service (e.g., commercial airliner, private jet, etc.).

The aerial transport facility can include a rooftop (and/or another portion above ground-level) having one or more landing zones to accommodate aerial vehicles (e.g., vertical takeoff and landing vehicles). In this manner, an aerial vehicle associated with the aerial transportation service can land on the rooftop of the aerial transport facility. In some implementations, the aerial facility can be ground-level and/or below ground-level.

An aerial facility can include one or more facility transport mechanisms to transport users within the facility. A facility transport mechanism can include, for example, an elevator (e.g., configured to go up, down, sideways, etc.), escalator, moving walkway, vehicles designated for transport within a facility, and/or other transport means within an aerial facility. The following describes the technology of the present disclosure within the context of elevator(s) for illustrative purposes only and is not meant to be limiting. The technology described herein can utilize, or be utilized with, other types of facility transport mechanisms.

An aerial facility can include a plurality of transition points. A transition point can be an area, passageway, portion, etc. of the aerial transport facility that is associated with a user transitioning from one transportation modality to another. For example, the transition point(s) can include a plurality of points of ingress. A point of ingress can include a passageway, gate, entrance way, check-in station etc. for entering the aerial facility (e.g., after riding a ground-based vehicle to arrive, etc.). The points of ingress can be located at various locations within and around the aerial facility (e.g., southwest entrance, northeast entrance, etc.). Additionally, or alternatively, the transition point(s) can include a plurality of points of egress (e.g., southwest exit, northeast exit, etc.). The points of egress can include a passageway, exit, etc. for leaving the aerial facility (e.g., to board a ground-based vehicle after riding in an aerial vehicle, etc.). The points of egress can be located at various locations within and around the aerial facility. Additionally, or alternatively, the transition point(s) can include a plurality of facility transport mechanisms (e.g., a plurality of elevators, etc.). In some implementation, a point of ingress can include and/or otherwise be associated with a facility transport mechanism (e.g., an elevator for getting to a rooftop of the aerial facility, etc.). In some implementations, a point of egress can include and/or otherwise be associated with a facility transport mechanism (e.g., an elevator for getting to a rooftop of the aerial facility, etc.).

By way of example, a plurality of elevators at the aerial transport facility can transport one or more users of the multi-modal transportation service to a rooftop (and/or other portion) of the aerial transport facility. In some implementations, the plurality of elevators at the aerial transport facility can include a first group or bank of elevators and a second group or bank of elevators. For example, each elevator in the first group of elevators can be smaller in size than each elevator in the second group of elevators. As another example, each elevator in the first elevator bank can have a different load capacity than each elevator in the second elevator bank. As yet another example, each elevator in the first elevator bank can have a different top speed than each elevator in the second elevator bank. In some implementations, the plurality of elevators can be dispersed at/behind points of ingress or egress associated with some aspect of the upcoming multi-modal transportation leg. For example, elevators can be distributed based on determined aerial transportation gates such that particular elevators transport users to a desirable location with regards to particular aerial vehicles. For instance, the particular aerial vehicles can be grouped by gates associated with a gate classification system (e.g., destination region, size of aerial vehicle, trip distance, etc.).

Example aspects of the present disclosure are directed to a computing system. The computing system can be configured to obtain multi-modal transportation data associated with the multi-modal transportation service. The multi-modal transportation data can include user data indicative of the multi-modal transportation itinerary for a user of the multi-modal transportation service. For example, the user data can include data indicative of an estimated weight of the payload associated with the user, data indicative of the multi-modal transportation itinerary associated with the user (e.g., indicting a modality of the ground-based transportation service associated with the first leg of the multi-modal transportation itinerary), data indicative of route(s)/types of route(s) associated with the multi-modal transportation itinerary of the user (e.g., a first leg route, a second leg route, a third leg route, etc.), historical data associated with the user, historical data associated with the aerial facility, timing data (e.g., estimate times of arrival, etc.).

The user data indicative of the estimated weight of the payload associated with the user can be provided as part of a check-in process that occurs when the user is switching from the ground-based transportation service (e.g., first leg) to the aerial-based transportation (e.g., second leg). In some implementations, the user can provide the estimated weight of the payload via an application running on a device (e.g., smartphone, laptop, tablet, etc.) associated with the user. In alternative implementations, the user can provide the estimated weight of the payload via one or more input devices (e.g., touchscreens, etc.) associated with a check-in station at the aerial transport facility.

In some implementations, the check-in station can be located on the ground floor of the aerial transport facility. In such implementations, an actual weight of the payload can be determined at the check-in station. For instance, the check-in station can include one or more weighing devices (e.g., scales, etc.) configured to determine an actual weight of the payload associated with the user (e.g., a weight of the user and/or a weight of the user's baggage/luggage, etc.).

In some implementations, the check-in station can be located on an intermediate floor that is positioned between the ground floor of the aerial transport facility and the rooftop (and/or another above or below-ground portion) of the aerial transport facility. In such implementations, the elevators at the aerial transport facility can include one or more weight sensors (e.g., load cells). The one or more weight sensors can be configured to obtain data indicative of an actual weight of the payload associated with the user. This eliminates a potential choke point in the check-in process, because the actual weight of the payload associated with the user need not be obtained as part of the check-in process at the check-in station. In this manner, an amount of time the user spends at the check-in station can be reduced.

The computing system can be configured to obtain facility data associated with the aerial transport facility. For instance, the facility data can be indicative of one or more parameters associated with at least some of the plurality of transition points at the aerial transport facility. The parameters can be indicative of, for example, (i) a location of at least one of the plurality of transition points (e.g., relative to a location for a subsequent transportation leg such as, for example, a proximity to a pick-up area of an assigned ground-transport vehicle, a boarding area for an assigned aerial vehicle, etc.), (ii) a size of each of the plurality of transition points, (iii) a capacity (e.g., weight, throughput, etc.) for each of the plurality of transition points, (iv) a top speed for each of the plurality of transition points, and/or other parameters. For example, the facility data can be indicative of one or more elevator parameters associated with each of the plurality of elevators at the aerial transport facility. In some implementations, the one or more elevator parameters can include at least one of a size of each of the plurality of elevators at the aerial transport facility, a load capacity (e.g., weight capacity) of each of the plurality of elevators, or a top speed of each of the plurality of elevators. Alternatively, or additionally, the one or more elevator parameters can include an amount of time remaining before each of the plurality of elevators is due for a scheduled maintenance event. In some implementations, the one or more elevator parameters can include whether or not a corresponding elevator of the plurality of elevators includes at least one of weight sensors (e.g., load cells) or display devices.

The computing system can be configured to determine one of the plurality of transition points as a selected transition point for the user based, at least in part, on the multi-modal transportation data and the facility data. Furthermore, the computing system can be configured to communicate one or more control signals associated with controlling operation of the selected transition point.

In some implementations, the computing system can select a transition point based, at least in part, on positioning the user in a more favorable location based on the upcoming transportation leg. For example, a transition point (e.g., point of ingress/egress, etc.) through which a user can board their aerial/ground vehicle or to a more favorable location with respect to boarding their aerial/ground vehicle. As another example, a transition point through which a user can obtain transportation to their aerial/ground vehicle or to a more favorable location with respect to their aerial/ground vehicle. By way of example, a computing system can determining a particular point of egress (e.g., a northeast exit, etc.) from a landing area of an aerial facility as a selected transition point for a user over other points of egress (e.g., a northwest exit, southwest exit, etc.) because that particular point of egress may lead the user to be more conveniently located with respect to the user's next transportation mode (e.g., a ground-based vehicle picking-up the user for a third leg of the multi-modal transportation service, etc.).

In some implementations, the computing system can determine a plurality of transitions points as selected transition points based at least in part on the parameters and/or the multi-modal transportation data. For example, the computing system can determine a first selected transition point that can lead a user to a second selected transition point. The first selected transition point can be point of egress can be a door or hallway that can lead a user to a second selected transition point such as an elevator. The computing system may make such a determination based on the payload associated with the user. For example, the data may indicate that the user is travelling with a payload above a certain threshold weight such that it may be preferable to utilize an elevator.

In some implementations, the computing system can be configured to queue or pre-queue one of the plurality of transition points (e.g., elevators, etc.) as a selected transition point (e.g., elevator, etc.) based, at least in part, on the estimated weight of the payload associated with the user. Furthermore, the computing system can be configured to refine its selection of one of the transition points as the selected transition point based, at least in part, on the actual weight of the payload associated with the user. For instance, the computing system may determine a first elevator of the plurality of elevators as the selected elevator based, at least in part, on the estimated weight of the payload of the user. The computing system may then determine a second elevator of the plurality of elevators is the selected elevator for the user based, at least in part, on the actual weight of the payload associated with the user. The computing system can be configured to change the selected elevator from the first elevator to the second elevator based, at least in part, on a discrepancy between the estimated weight of the payload associated with the user and the actual weight of the payload associated with the user.

In some implementations, the computing system can select transition point based, at least in part, on a transportation modality indicated in the user data indicative of the multi-modal transportation itinerary for the user. For instance, when the user selected a first transportation modality (e.g., scooter, bicycle, etc.) indicative of ground-based vehicles lacking space (e.g., a trunk) to accommodate luggage, the computing system can be configured to select a smaller elevator from amongst the plurality of elevators at the aerial transport facility and/or a point of ingress that is generally for users with smaller luggage. Conversely, when the user selected a second transportation modality (e.g., autonomous vehicle, human-operated vehicle) indicative of ground-based vehicles having space to accommodate luggage, the computing system can be configured to select a larger elevator from amongst the plurality of elevators at the aerial transport facility and/or a point of ingress that is generally for users with larger or more luggage. Additionally, or alternatively, a point of egress at a destination aerial facility can be selected based at least in part on the type of transportation modality of a previous transportation leg. This can be, for instance, a point of egress associated with a stairwell rather than an elevator for a user estimated to have less luggage.

In some implementations, the computing system can select a transition point based, at least in part, on the user data indicative of a type of route (e.g., associated with the second leg of the multi-modal transportation itinerary). By way of example, when the route associated with the second leg of the multi-modal transportation itinerary is of a first type (e.g., entertainment) that would not require luggage, the computing system can be configured to select a smaller elevator from amongst the plurality of elevators. Conversely, when the route associated with the second leg of the multi-modal transportation itinerary is of a second type (e.g., a trip to an airport) that is different than the first type (e.g., entertainment) and would require luggage, the computing system can be configured to select a larger elevator from amongst the plurality of elevators and/or a point of ingress/egress associated therewith.

In some implementations, the computing system can select a transition point based, at least in part, on the user data indicative of whether a user is able-bodied (e.g., if the user uses a wheelchair, scooter, or otherwise needs mobility assistance). Such determination can be made based at least in part on, for example, information voluntarily entered by the user into a user profile, which can be indicated in the multi-modal transportation data. For example, when the computing system determines that a user is not able-bodied, the computing system can be configured to select a compatible elevator (e.g., an elevator with a wider entrance, a larger elevator, etc.) from amongst the plurality of elevators, regardless of alternative user data indicating user payload or lack thereof. As another example, when the computing system determines that a user is not able-bodied, the computing system can be configured to select a point of ingress or egress such as a doorway compatible with a user's capabilities (e.g., a wide door frame to accommodate a wheelchair, a ramp exit, etc.) from amongst the plurality of points of ingress or egress.

In some implementations, the multi-modal transportation data can include historical data associated with the user of the multi-modal transportation service. For instance, the historical data can be indicative of a weight of luggage the user took with them on previous flights. In some implementations, the computing system can be configured to determine one of the plurality of transition points as the selected transition point for the user based, at least in part, on the historical data. For instance, if the historical data indicates that the user typically (e.g., more often than not) brings luggage, the computing system can be configured to select a larger elevator (and/or a point of ingress/egress associated therewith) from amongst the plurality of elevators (and/or points of ingress/egress) at the aerial transport facility. In this manner, the larger elevator can accommodate both the user and any luggage the user may bring with them on the aerial vehicle. Conversely, if the historical data indicates that the user does not typically bring luggage, the computing system can be configured to select a smaller elevator from amongst the plurality of elevators at the aerial transport facility.

In some implementations, the user data indicative of the multi-modal transportation itinerary can include data indicative of estimated time of arrival for the user at the aerial transport facility. In such implementations, the computing system can be configured to select one of the transition points to be available at the estimated time of arrival. In this manner, a potential choke point (e.g., an elevator not being available when the user arrives at the aerial transport facility, a point of ingress/egress, etc.) associated with the user switching between the ground-based transportation service and the aerial-based transportation service (or vice versa) can be avoided.

In some implementations, the user data indicative of the multi-modal transportation itinerary can include an estimated time of arrival of the user at the destination location. For instance, the destination location can be an airport, and the estimated time of arrival can correspond to a boarding time associated with a flight departing from the airport. When the user is running late, the computing system can prioritize the user relative to other users of the multi-modal transportation service needing a transition point at the aerial transport facility so that the user running late does not have to wait on at the transition point at the aerial transport facility. In this manner, the computing system can reduce or eliminate chokepoints associated with the user switching between the ground-based transportation service and the aerial-based transportation service (or vice versa) to avoid the user violating the estimated time-of-arrival (e.g., boarding time, etc.) at the destination location (e.g., airport, etc.).

In some implementations, the multi-modal transportation data can include historical data associated with the aerial transport facility. For instance, the historical data can be indicative of demand for transition point usage (e.g., elevator trips, user traffic associated with an ingress/egress point, etc.) at the aerial transport facility over a given period of time (e.g., day, week, month, year, etc.). In some implementations, the historical data indicative of demand for transition point usage can include a breakdown of a total number of users of the multi-modal transportation service and a total number of non-users (e.g., person that live or work at the aerial transport facility, etc.) of the multi-modal transportation service that have utilized the particular transition point. In such implementations, the computing system can be configured to book, reserve, etc. time at the aerial transport facility based, at least in part, on the historical demand for transition point usage associated with users of the multi-modal transportation service.

In some implementations, the one or more commands signals communicated by the computing system can be associated with reserving a transition point at the aerial transport facility to accommodate the demand for transition points associated with users of the multi-modal transportation service. This can occur, for example, in the event the entity that coordinates/manages the multi-modal transportation service also owns/controls the aerial transport facility. For instance, the one or more commands signals can be communicated to an elevator booking system for the aerial transport facility. The elevator booking system can be configured to reserve enough elevator time to accommodate the demands of elevator trips associated with users of the multi-modal transportation service. In some implementations, remaining elevator time at the aerial transport facility can be available for reservation by persons that live or work at the aerial transport facility and/or potentially another entity providing transportation services at the aerial transport facility. In another example, a particular point of ingress can be reserved to accommodate a high volume of users that may be arriving at the aerial transport facility and/or a particular point of egress can be reserved to accommodate a high volume of users that may be leaving an aerial transport facility.

In some implementations, the one or more command signals communicated by the computing system can be associated with a request to reserve transition point(s) at the aerial transport facility to accommodate the demand for transition point(s) associated with users of the multi-modal transportation service. This can occur, for example, in the event the entity that owns/controls the aerial transport facility is different than the entity that coordinates the multi-modal transportation service. By way of example, if the entity that owns/controls aerial transport facility is unable to accommodate the demand for elevator trips involving users of the multi-modal transportation service, the entity of multi-modal transportation service can reduce throughput at the aerial transport and increase throughput at neighboring aerial transport facilities.

In some implementations, the computing system can be configured to determine whether the user is at the selected transition point. For instance, the computing system can obtain location data (e.g., global positioning system data, etc.) from a user device (e.g., smartphone, tablet, etc.) associated with the user. When the location data indicates that the user is in the wrong transition point (that is, not the selected transition point for the user) at the aerial transport facility, the computing system can provide one or more notifications to the user device. For example, the one or more notifications can inform the user that he or she is in the wrong point of egress and, in some implementations, can provide directions to the selected point of egress for the user. Furthermore, in some implementations, the computing system can provide the one or more notifications to one or more display devices (e.g., display screen(s), etc.) of the wrong transition point in which the user is currently located. Alternatively, or additionally, the computing system can provide one or more commands signals associated with holding the selected transition point if applicable (e.g., an elevator, exit, etc.) for the user since the user is in close proximity (e.g., at the aerial transport facility, etc.) to the selected transition point.

In some implementations, the computing system can be configured to communicate information associated with the multi-modal transportation service to a user device (e.g., smartphone, tablet, etc.) associated with the user. For instance, the information can be associated with the multi-modal transportation service and can be provided to the user device based, at least in part, on the location of the user. For instance, when location data (e.g., GPS data, etc.) for the user device indicates the user is arriving at the first aerial transport facility, the computing system can communicate information to the user device that is indicative of a map of the first aerial transport facility. More specifically, the information can indicate where the transition points are located on the ground floor of the aerial transport facility.

When the location data associated with the user device indicates the user is within and/or within a proximity of the transition point, the computing system can, in some implementations, provide information to the user device that is indicative of a map of the rooftop (and/or another ground-level or above or below ground portion) of the first aerial transport facility. In this manner, the user can become familiar with the layout of the rooftop before exiting the transition point (e.g., elevator, etc.). Furthermore, when the location data associated with the user device indicates the user is departing from the first aerial transport facility, the computing system can communicate information indicative of a layout of the second aerial transport facility. In this manner, the user can become familiar with the layout of the second aerial transport facility before deboarding the aerial vehicle.

When the location data associated with the user device indicates the user is within a transition point at the second aerial transport facility, the computing system can, in some implementations, be configured to communicate information associated with a third leg of the multi-modal transportation itinerary for the user. For instance, the information can include details (e.g., driver name, make of vehicle, model of car, license plate number, etc.) about the ground-based transportation service associated with the third leg of the multi-modal transportation itinerary for the user. A selected transition point can be one that allows the user to access an area most easily for transitioning to a ground-based transportation service.

In some implementations, the computing system can provide information to the user via one or more display devices associated with the selected transition point (e.g., elevator, point of ingress/egress). The information can be associated with the multi-modal transportation service. For instance, the information can include, for instance, frequently asked questions associated with the multi-modal transportation service. In this manner, the information displayed on the one or more display devices can improve the user's experience of the multi-modal transportation service.

In some implementations, the information displayed on the one or more display devices of the selected transition point (e.g., elevator, entrance, check-in station, etc.) can include a map of the rooftop of the first aerial transport facility. In this manner, the user can become familiar with the layout (e.g., landing zones) of the rooftop prior to arriving at the rooftop. Alternatively, or additionally, the information can include a map of the rooftop of second aerial transport facility. In this manner, the user can become familiar with the layout of the rooftop of the second aerial transport facility before the aerial vehicle lands on the rooftop of the second aerial transport facility.

In some implementations, the computing system can be configured to communicate one or more control signals associated with controlling operation of a lighting system associated with the selected transition point (e.g., elevator, etc.) for the user. For instance, if the rooftop of the first aerial transport facility is brightly lit, the one or more control signals can be associated with brightening the interior lighting for the selected elevator. For example, the lighting in the selected elevator can be brightened to a determined brightness based on the rooftop brightness when the user enters the selected elevator. Alternatively, the lighting in the selected elevator can start at a dimmer interior lighting level and be brightened gradually after a user enters the selected elevator (e.g., throughout the user riding the selected elevator) such that the interior lighting level reaches the determined brightness based on the rooftop brightness prior to the user exiting the selected elevator. Specifically, when the user enters the selected elevator, the interior lighting for the selected elevator can start at a determined brightness level based on the brightness of the selected elevator. As another example, if the rooftop of the first aerial transport facility is dimly lit, the one or more control signals can be associated with dimming the interior lighting for the selected elevator. For example, the lighting in the selected elevator can be dimmed to a determined brightness based on the rooftop brightness when the user enters the selected elevator. Alternatively, the lighting in the selected elevator can start at a brighter interior lighting level and be dimmed gradually after a user enters the selected elevator (e.g., throughout the user riding a selected elevator) such that the interior lighting level reaches the determined brightness based on the rooftop brightness prior to the user exiting the selected elevator. Specifically, when the user enters the selected elevator, the interior lighting for the selected elevator can start at a determined brightness level based on the brightness of the selected elevator. In this manner, the user's eye can become acclimated to the interior lighting while riding the selected elevator and can therefore be less likely to be affected by the rooftop lighting. If the interior of the selected elevator were lit at a substantially different level from the rooftop, the user could be slower to exit the selected elevator at the rooftop, because the user's eye would need time to adjust to the discrepancy between the intensity (e.g., brightness) of the interior lighting for the selected elevator and the exterior lighting for the rooftop. In this manner, adjusting the brightness of the interior lighting for the selected elevator based on the brightness of the exterior lighting for the rooftop can improve the user-experience and reduce or eliminate a delay (e.g., choke point) associated with the exiting the elevator on the rooftop of the first aerial transport facility to board the aerial vehicle.

In another example, the computing system can be configured to communicate one or more control signals associated with controlling one or more lighting conditions of a lighting source associated with a transition point. For example, the computing system can send one or more control signals to activate lighting elements, cause lighting elements to emit a certain color/frequency/other characteristic, emit light from a sign, etc. to indicate and/or indicate a path to the selected transition point (e.g., check-in station, exit, etc.).

In some implementations, the computing system can communicate control signals for a plurality of transition points based on a plurality of users. This can include indicating a first transition point (and/or a path thereto) for a first user and a second transition point (and/or a path thereto) for a second user. For example, a first user device of a first user can obtain a notification that indicates the first user is to utilize a first point of egress (e.g., northwest exit, etc.) that will be indicated by a first color (e.g., blue, etc.). The computing system can communicate control signals that cause light source(s) associated with the first point of egress to emit the first color of light. This can indicate the location of the first point of egress to the user and/or a path lit in the first color for the first user to follow to the first point of egress. A second user device of a second user can obtain a notification that indicates the second user is to utilize a second point of egress (e.g., southeast exit, etc.) that will be indicated by a second color (e.g., red, etc.). The computing system can communicate control signals that cause light source(s) associated with the second point of egress to emit the second color of light. This can indicate the location of the second point of egress to the user and/or a path lit in the second color for the second user to follow to the first point of egress. As such, the computing system can indicate to multiple users their respective transition points, increasing the efficiency of multiple users moving through the aerial transport facility at concurrent times.

In some implementations, the computing system can be configured to communicate information for display on one or more display devices of transition point (e.g., elevator, etc.) the user is located within and/or within proximity of at the second aerial transport facility. For instance, if multi-modal transportation itinerary includes a third leg associated with transporting the user from the second aerial transport facility to the destination location, the computing system can be configured to communicate information associated with the third leg. When the third leg includes a ground-based transportation service having a first transportation modality (e.g., scooter, bike, etc.), the information can include a map of the closest bike/scooter station to the second aerial transport facility. Conversely, when the third leg includes a ground-based transportation service having a second transportation modality (e.g., autonomous vehicle, human-operated vehicle, etc.) that is different than the first transportation modality, the information can include information (e.g., license plate, make of vehicle, model of vehicle, etc.) associated with the second transportation modality. Furthermore, in implementations in which the ground-based vehicle is operated by a human driver, the information can include the name of the human driver. A transition point can be selected such that the user is conveniently located to transition to the vehicle for the third leg of the multi-modal transportation itinerary.

In some implementations, the third leg can include an aerial-based transportation service, such as a commercial-flight. In such implementations, the information can include details (e.g., boarding time, departing time, gate number, etc.) associated with the commercial flight. Additionally, in some implementations, the information can include details (e.g., security wait times, etc.) associated with an airport from which the commercial flight is departing.

Example aspects of the present disclosure can provide a number of improvements to computing technology. For instance, the computing system of the present disclosure reduces choke points associated with switching between modalities of the multi-modal transportation service. For example, the computing system can obtain multi-modal transportation data indicative of a multi-modal transportation itinerary for a user requesting the multi-modal transportation service. Furthermore, the computing system can obtain facility data for an aerial transport facility associated with the multi-modal transportation service. The facility data can be indicative of parameters associated with a plurality of transition points at the aerial transport facility. The computing system can be configured to determine one of the plurality of transition points as a selected transition point for the user based, at least in part, on the multi-modal transportation data and the facility data. In this manner, a transition can be selected that reduces choke points (e.g., time delays, etc.) associated with switching between modalities of the multi-modal transportation service. For instance, the computing system can be configured to determine a larger transition point (e.g., elevator, etc.) of the plurality of transition points as the selected transition point for the user when the multi-modal transportation data indicates that that the user is bringing luggage aboard the aerial vehicle. As such, instances can be avoided in which the user and their luggage pass through separate transition points at the aerial transport facility and thereby increase the chances of the luggage being separated from the user while switching between modalities of the multi-modal transportation service.

In addition, the computing system can be configured to provide information for display on one or more display devices associated with the selected transition point (e.g., elevator, other facility transport mechanism, point of ingress/egress, etc.) to improve the experience for the user of the multi-modal transportation service. For instance, the information can include a map of the rooftop of the departing aerial transport facility if the user has not previously used the multi-modal transportation service. In this manner, the user can become familiar with the layout of the rooftop and, as result, can be informed as to where the user needs to go on the rooftop in order to board the aerial vehicle. Additionally, the information can include a map of the rooftop of the destination aerial transport facility. In this manner, the user can become familiar with the layout of the rooftop before the aerial vehicle lands at the destination facility and, as a result, will be less likely to waste time searching for transition points to utilize at the destination aerial transport facility.

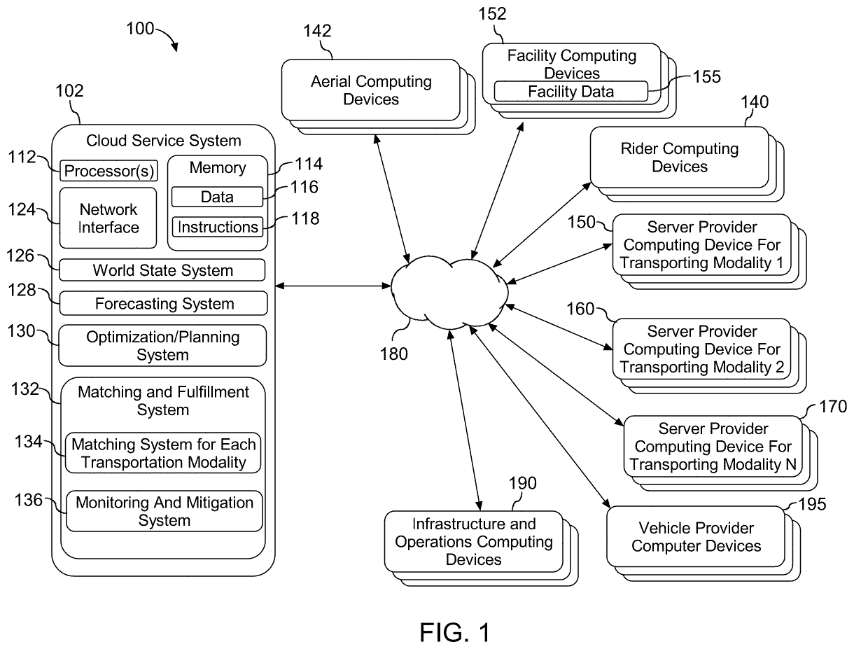

Referring now to the FIGS., FIG. 1 depicts a block diagram of a computing system 100 according to example embodiments of the present disclosure. The computing system 100 can include a cloud service computing system 102 that can operate to control, route, monitor, and/or communicate with aircraft (e.g., VTOL aircraft). These operations can be performed as part of a multi-modal transportation service for passengers, for example, including travel by ground vehicle and travel by aircraft (e.g., VTOL aircraft).

The cloud service computing system 102 can be communicatively connected over a network 180 to one or more rider computing devices 140, one or more service provider computing devices 150 for a first transportation modality, one or more service provider computing devices 160 for a second transportation modality, one or more service provider computing devices 170 for an Nth transportation modality, one or more infrastructure operations computing devices 190, and one or more vehicle provider computing devices 195. In addition, the cloud service computing system 102 can be communicatively connected over the network 180 to one or more aerial computing devices 142, and/or one or more facility computing devices 152. In some implementations, the one or more facility computing devices 152 can store and/or otherwise be associated with facility data 155.

Each of the computing devices 140, 142, 150, 152, 160, 170, 190, 195 can include any type of computing device such as a smartphone, tablet, hand-held computing device, wearable computing device, embedded computing device, navigational computing device, vehicle computing device, desktop, laptop, server computing system, etc. A computing device can be associated with a computing system, A computing device can include one or more processors and a memory (e.g., similar to as will be discussed with reference to processors 112 and memory 114). Although service provider devices are shown for N different transportation modalities, any number of different transportation modalities can be used, including, for example, less than the three illustrated modalities (e.g., one or more modalities can be used).

The cloud service computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage media, such as RAM, ROM, EEPROM, EPROM, one or more memory devices, flash memory devices, etc., and combinations thereof.

The memory 114 can store information that can be accessed by the one or more processors 112. For instance, the memory 114 (e.g., one or more non-transitory computer-readable storage mediums, memory devices) can store data 116 that can be obtained, received, accessed, written, manipulated, created, and/or stored. In some implementations, the cloud service computing system 102 can obtain data from one or more memory device(s) that are remote from the cloud services computing system 102.

The memory 114 can also store computer-readable instructions 118 that can be executed by the one or more processors 112. The computer-readable instructions 118 can be software written in any suitable programming language or can be implemented in hardware. Additionally, or alternatively, the computer-readable instructions 118 can be executed in logically and/or virtually separate threads on the one or more processors 112. For example, the memory 114 can store the computer-readable instructions 118 that, when executed by the one or more processors 112, cause the one or more processors 112 to perform any of the operations and/or functions described herein.

The cloud service computing system 102 can be, for example, an operations computing system associated with a service entity. The cloud service computing system 102 can be configured to manage, coordinate, and dynamically adjust a multi-modal transportation service via a transportation platform of the service entity. The service entity can include, for example, a transportation network provider. The transportation network provider can be an entity that coordinates, manages, etc. transportation services that include aerial and/or other types of vehicles. The transportation network provider can be associated with one or more transportation platforms. A transportation platform can be utilized for the provision of transportation services via one or more vehicles available, online, etc. to the transportation platform. In some implementations, the service entity can be a vehicle provider, as further described herein. The vehicles used to provide the transportation services can be owned, operated, leased, etc. by the service entity (e.g., the transportation network provider). Additionally, or alternatively, one or more of the vehicles used to provide the transportation service be owned, operated, leased, etc. by an entity other than the service entity (e.g., a third party vehicle provider).

The cloud service computing system 102 can include a number of different systems such as a world state system 126, a forecasting system 128, an optimization/planning system 130, and a matching and fulfillment system 132. The matching and fulfillment system 132 can include a different matching system 134 for each transportation modality and a monitoring and mitigation system 136. Each of the systems 126-136 can be implemented in software, firmware, and/or hardware, including, for example, as software which, when executed by the processors 112 cause the cloud service computing system 102 to perform desired operations. The systems 126-136 can cooperatively interoperate (e.g., including supplying information to each other).

The world state system 126 can operate to maintain data descriptive of a current state of the world. For example, the world state system 126 can generate, collect, and/or maintain data descriptive of predicted passenger demand; predicted service provider supply; predicted weather conditions; planned itineraries; pre-determined transportation plans (e.g., flight plans) and assignments; current requests; current ground transportation service providers; current transportation node operational statuses (e.g., including re-charging or re-fueling capabilities); current aircraft statuses (e.g., including current fuel or battery level); current aircraft pilot statuses; current flight states and trajectories; current airspace information; current weather conditions; current communication system behavior/protocols; and/or the like. The world state system 126 can obtain such world state information through communication with some or all of the computing devices 140, 142, 150, 152, 160, 170, 190, 195.

For example, rider computing devices 140 can provide current information about passengers. Rider computing devices 140, for instance, can include one or more user device associated with a passenger of one or more service providers. The rider computing devices 140 can monitor the progress of a respective passenger and provide current information about the passenger to the world state system 126. Computing devices 142, 150, 160, 170, and 195 can provide current information about service providers and/or aircraft utilized by service providers. Infrastructure and operations computing devices 190 can provide current information about the status of infrastructure and associated operations/management.

In addition, or alternatively, the facility computing devices 152 can provide current information (e.g., facility data 155) about an aerial transport facility. A facility computing device 152, for example, can be associated with an aerial transport facility. The facility computing device 152 can monitor current information of the aerial transport facility and provide the current information to the world state system 126. In some implementations, the facility computing devices 152 can be included in the cloud service computing system 102 and/or one or more functions/systems of the cloud service computing system 102 can be included in the facility computing device 152.

The forecasting system 128 can generate predictions of the demand and supply for transportation services at or between various locations over time. The forecasting system 128 can also generate or supply weather forecasts. The forecasts made by the system 128 can be generated based on historical data and/or through modeling of supply and demand. In some instances, the forecasting system 128 can be referred to as an RMR system, where RMR refers to “routing, matching, and recharging.” The RMR system can be able to simulate the behavior of a full day of activity across multiple ride share networks.

The optimization/planning system 130 can generate transportation plans for various transportation assets and/or can generate itineraries for passengers. For example, the optimization/planning system 130 can perform flight planning. As another example, optimization/planning system 130 can plan or manage/optimize itineraries which include interactions between passengers and service providers across multiple modes of transportation.

The matching and fulfillment system 132 can match a passenger with a service provider for each of the different transportation modalities. For example, each respective matching system 134 can communicate with the corresponding service provider computing devices 150, 160, 170 via one or more APIs or connections. Each matching system 134 can communicate trajectories and/or assignments to the corresponding service providers. Thus, the matching and fulfillment system 132 can perform or handle assignment of ground transportation, flight trajectories, take-off/landing, etc.

For example, the one or more aerial computing devices 142 can include a service provider computing devices 150, 160, 170 associated with an aircraft. The aerial computing devices 142 can include, for instance, a user computing device associated with a pilot of the aircraft, a vehicle computing device associated with the aircraft, etc. For instance, the aircraft can include an autonomous aircraft with a vehicle computing system (e.g., aerial computing device 142) configured to facilitate the movement of the aircraft.

The monitoring and mitigation system 136 can perform monitoring of user itineraries and can perform mitigation when an itinerary is subject to significant delay (e.g., one of the legs fails to succeed). Thus, the monitoring and mitigation system 136 can perform situation awareness, advisories, adjustments and the like. The monitoring and mitigation system 136 can trigger alerts and actions sent to the computing devices 140, 142, 150, 152, 160, 170, 190, and 195. For example, passengers, service providers, aircraft, and/or operations personnel can be alerted when a certain transportation plan has been modified and can be provided with an updated plan/course of action. Thus, the monitoring and mitigation system 136 can have additional control over the movement of aircraft, ground vehicles, pilots, and passengers.

In some implementations, the cloud service computing system 102 can store or include one or more machine-learned models. For example, the models can be or can otherwise include various machine-leamed models such as support vector machines, neural networks (e.g., deep neural networks), decision-tree based models (e.g., random forests), or other multi-layer non-linear models. Example neural networks include feed-forward neural networks, recurrent neural networks (e.g., long short-term memory recurrent neural networks), convolutional neural networks, or other forms of neural networks.

In some instances, the service provider computing devices 150, 160, 170 can be associated with autonomous vehicles (e.g., autonomous VTOL aircraft). Thus, the service provider computing devices 150, 160, 170 can provide communication between the cloud service computing system 102 and an autonomy stack of the autonomous vehicle which autonomously controls motion of the autonomous vehicles.

The infrastructure and operations computing devices 190 can be any form of computing device used by or at the infrastructure or operations personnel including, for example, devices configured to perform passenger security checks, luggage check in/out, re-charging/re-fueling, safety briefings, vehicle check in/out, and/or the like.

In some implementations, the computing system 100 can include one or more vehicle provider computing devices 195. The vehicle provider computing device(s) 195 can be associated with one or more vehicle providers. A vehicle provider can be an entity (e.g., a first party entity, third party entity, etc.) that operates, owns, leases, controls, manufactures, etc. one or more vehicles. For example, a vehicle provider can include an operator, vendor, supplier, manufacturer, etc. of one or more aircraft. Each vehicle provider can be associated with respective vehicle provider computing device(s) 195. The vehicle provider computing device(s) 195 can be configured to manage the vehicles associated with that vehicle provider. This can include, for example, overseeing itineraries, accepting/rejecting transportation services, suggesting candidate vehicles, overseeing maintenance, controlling online/offline status, etc. A vehicle provider computing device 195 can communicate with the cloud service computing system 102 directly and/or indirectly. A vehicle associated with a vehicle provider can communicate directly with the cloud service computing system 102 and/or indirectly via the vehicle provider computing device(s) 195 (e.g., acting as an intermediary, etc.).

The vehicle providers' vehicles that are available for transportation services can include one or more types of vehicles. For example, the vehicle provider(s) can include a plurality of aerial vehicle providers, where each vehicle provider can provide a different type of aircraft (e.g., VTOL, helicopter, etc.) and/or a different model of aircraft. In some implementations, a vehicle provider can provide more than one type, version, model, etc. of aircraft available for the cloud service computing system 102 and/or the service entity. The different types of aircraft can include different shapes, sizes, capacities, capabilities, parameters, autonomy abilities (e.g., autonomous, semi-autonomous, manual, etc.), landing gear, hardware, etc. Although the following describes vehicle providers as aerial vehicle providers, this is provided as an example only and is not intended to be limiting. For example, vehicle providers can include providers of other types of vehicles such as ground-based vehicles (e.g., cars, bicycles, scooters, etc.) and/or other modes of transportation.

The cloud service computing system 102 and the vehicle provider computing device(s) 195 can communicate information to one another. The vehicle provider computing device(s) 195 can communicate various types of information to the cloud service computing system 102. For example, the vehicle provider computing device(s) 195 can provide data indicative of: status information (e.g., online/offline status, on-trip status, vehicle availability for transportation service, etc.), acceptance and/or rejection of a service (e.g., an aerial transportation service, etc.), maintenance information, vehicle parameters (e.g., weight capacity, noise signature, number of seats, set configuration, flight hours, charging/refueling parameters, hardware, temperature control parameters, operational restrictions, etc.), flight schedules, candidate vehicles, locations, updates of any such information, etc. The cloud service computing system 102 can communicate various types of information to a vehicle provider computing device 195. For example, the cloud service computing system 102 can provide data indicative of: transportation services (e.g., services needed, specific vehicle requests, etc.), vehicle itineraries, status information (e.g., service in progress, etc.), vehicle parameter updates, payloads, locations, user/passenger information (e.g., anonymized and securely protected, etc.), air traffic information, environmental data (e.g., expected wind speeds, weather information, etc.), and/or other types of information.

The service entity associated with the cloud service computing system 102 can utilize vehicles associated with various parties. In some implementations, the service entity can also be a vehicle provider (e.g., a first party entity, etc.). For example, the service entity can utilize vehicles (e.g., ground-based vehicles, aircraft, etc.) within the service entity's fleet that are online with the transportation platform, etc. Additionally, or alternatively, the service entity can utilize vehicles provided by a vehicle provider from the vehicle provider's fleet. A fleet can include one or a plurality of vehicles. A vehicle provider can make one or more of the vehicles in its fleet available to the cloud service computing system 102. For example, the vehicle provider computing device(s) 195 and/or a service provider computing device of a vehicle can log into a transportation platform, provide data indicating a vehicle is available, facilitate the vehicle being actively engaged with the transportation platform, and/or otherwise inform a service entity of a vehicle's availability. In some implementations, a vehicle provider computing device 195 can provide data indicative of vehicles that are not online with the service entity and that could or may become available.

The vehicles to be utilized for a particular multiple-modal transportation service can be determined in a variety of manners. The cloud service computing system 102 (and the associated service entity) may have varying levels of control over the vehicle(s) that perform its services. For example, a vehicle provider may make one or more vehicles available to the service entity. The service entity may be able to determine which vehicles are to perform which legs of a transportation without input from the vehicle provider. Thus, the service entity may have full control of the vehicles online with the platform.

In some implementations, the service entity may determine transportation service assignments for vehicles of the service entity, while a vehicle provider may be able to determine (e.g., accept, reject, etc.) transportation service assignments for its vehicles. For example, the cloud service computing system 102 can provide data indicative of a flight leg, itinerary, etc. to one or more vehicle provider computing devices 195. The data can indicate a request for a specific vehicle or a request for any available vehicle within the vehicle provider's available fleet to perform the transportation service (e.g., flight transportation between two vertiports, etc.). In some implementations, the data may include certain parameters (e.g., weight capacity, number of seats, noise parameters, etc.) needed and/or preferred by the service entity, user, etc. The vehicle provider computing device 195 can process this data and determine whether a specifically requested vehicle and/or another vehicle associated with the vehicle provider will provide the requested service (e.g., perform a flight for the second leg of a multi-model transportation service). The vehicle provider computing device 195 can communicate data indicative of the acceptance or rejection to the cloud service system 102. In some implementations, data indicative of the requested transportation service can be communicated to a service provider computing device 150, 160, 160 associated with a vehicle of a vehicle provider's fleet (e.g., an aircraft, etc.) and the service provider can accept or reject the service (e.g., the flight transportation, etc.).

In some implementations, one or more vehicle provider computing device(s) 195 can communicate data indicative of a plurality of candidate vehicles that could provide the requested service (e.g., perform an aerial transportation service for a flight leg). The cloud service computing system 102 can select from among the plurality of candidate vehicles and communicate data indicative of the selected candidate vehicle to the vehicle provider computing device(s) 195.

In some implementations, the service entity can be an aerial vehicle provider and can coordinate with one or more ground-based vehicle providers to generate a multi-modal itinerary. For example, a user can request transportation via a software application running on a user device. The software application can be associated with the service entity (e.g., the aerial vehicle provider). The cloud service computing system 102 can then communicate with one or more ground-based vehicle providers to determine ground-based vehicle(s) that may be available for (and/or accept) transportation for one or more legs of a multi-modal itinerary (e.g., a first leg to a first aerial transport facility, a third leg from a second transport facility, etc.). In this manner, the service entity may build a multi-modal itinerary in an inside-out manner starting with a middle leg (e.g., an aerial leg).

The cloud service computing system 102 can determine which vehicles are to perform which transportations legs in an on-demand manner or based at least in part on a schedule. For example, the cloud service computing system 102 can initially generate a flight itinerary in response to receiving a first request. In some implementations, the cloud service computing system 102 can have a pre-determined flight schedule and offer aerial transport (e.g., for multi-modal transportation services, etc.) in the event that a user's time constraints and locations can be met with the pre-determined flight schedule.

In some implementations, the vehicle provider may provide initial input regarding vehicle scheduling. For example, the vehicle provider computing device 195 can communicate data indicative of a flight schedule for one or more aircrafts between various aerial facilities (e.g., vertiports, etc.). The vehicle provider computing device 195 can communicate initial seat availability, as well as updates throughout an operational time period (e.g., throughout a day, etc.), to the cloud service computing system 102. The cloud service computing system 102 can utilize this flight schedule to determine itineraries for users and/or vehicles of the transportation service. For example, the cloud service computing system 102 can use the flight schedule to determine whether to offer a multi-modal transportation service with an aerial leg to a user and/or to generate itineraries with aerial legs based on the flight schedule. In some implementations, the flight schedule can be an initial flight schedule for an operational time period. For example, the vehicle provider computing device(s) 195 can provide data indicative of the initial flights for the available vehicles at the beginning of a day. The cloud service computing system 102 can utilize this data to determine multi-modal transportation services at the beginning of the day. Thereafter, the cloud service computing system 102 can determine the flight itineraries in an on-demand manner to meet user/passenger demand throughout the operational time period.

Additionally, or alternatively, the cloud service computing system 102 can communicate data indicative of a schedule (e.g., initial, for full operational period, etc.) to the vehicle provider computing device(s) 195. The vehicle provider computing device(s) 195 can process the schedule and communicate data indicative of which vehicles (e.g., aircraft, etc.) are available for which services (e.g., flight legs, etc.).

In some implementations, the cloud service computing system 102 can communicate data indicative of a transportation service (e.g., one or more flight legs, schedules, etc.) to a plurality of vehicle provider computing device(s) 195. One or more of the vehicle provider computing device(s) 195 can process the data and communicate data indicative of vehicle(s) (e.g., aircraft, etc.) that are available to fulfill the transportation service (e.g., perform aerial transportation for one or more leg(s), etc.) to the cloud service computing system 102. In some implementations, the vehicle provider computing device(s) 195 can provide information indicative of vehicle parameters, costs/fees, etc. The cloud service computing system 102 can be configured to analyze the responses from the plurality of vehicle provider computing devices 195 to determine a service provider. For example, the cloud service computing system 102 can utilize rules, models, algorithms, etc. that weigh the various vehicle parameters to select an aircraft for a user to ensure that the user's estimated arrival times are not violated, to minimize costs, etc.

The vehicle provider computing device(s) 195 and/or the cloud service computing system 102 can communicate data indicative of the transportation service (e.g., flight itinerary data, etc.) to a service provider computing device 150, 160, 170 associated with a vehicle. For example, a vehicle provider computing device 195 or the cloud service computing system 102 can communicate data indicative of a flight (e.g., times, locations, users, payload, etc.) to a computing device onboard an aircraft and/or a device of a pilot of the aircraft.

The one or more networks 180 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the one or more networks 180 can be accomplished, for instance, via a network interface using any type of protocol, protection scheme, encoding, format, packaging, etc.

For example, the cloud service computing system 102 can be configured to manage, coordinate, and dynamically adjust a multi-modal transportation service via a transportation platform. The multi-modal transportation service can include a plurality of transportation legs, one of which (e.g., a second transportation leg) can include an aerial transport of a user. For example, the cloud service computing system 102 can obtain a request for a transportation service (e.g., from a rider computing device 140). The request for the transportation service can include at least a request for an aerial transport of a user of the transportation platform. The cloud service computing system 102 can obtain the request from a user device (e.g., a rider computing device 140) associated with the user of the transportation platform.

The request for the transportation service can include an origin location and a destination location. In some instances, unless specified otherwise, the origin of the transportation service can be assumed to be a current location of the user (e.g., as indicated by location data such as GPS data received from a rider computing device 140 and/or as input by the user, etc.). A user can also supply a desired destination (e.g., by typing the destination into a text field which may, for example, provide suggested completed entries while the user types, etc.).

A multi-modal transportation itinerary from the origin location to the destination location can be generated based on the request for the transportation service. The multi-modal transportation itinerary can include two or more transportation legs (e.g., a first transportation leg, a second transportation leg, a third transportation leg, etc.) between the origin location and the destination location specified in the request. The two or more transportation legs can include travel via two or more different transportation modalities such as, for example: cars, motorcycles, light electric vehicles (e.g., electric bicycles or scooters), buses, trains, aircraft (e.g., airplanes), watercraft, walking, and/or other transportation modalities. Example aircrafts can also include helicopters and other vertical take-off and landing aircraft (VTOL) such as electric vertical take-off and landing aircraft (eVTOL). The vehicles can include non-autonomous, semi-autonomous, and/or fully-autonomous vehicles.

The cloud service computing system 102 can facilitate the ability of a user to receive transportation on one or more of the transportation legs included in the multi-modal transportation itinerary. As an example, the cloud service computing system 102 can interact with a plurality of devices (e.g., one or more service provider computing devices 150, 160, 170, one or more facility computing device 152, one or more aerial computing devices 142, one or more infrastructure and operations computing devices 190, one or more vehicle provider computing devices 195, etc.) to match the user with one or more transportation service providers for each transportation leg of the multi-modal transportation itinerary. For example, the cloud service computing system 102 can book or otherwise reserve a seat in, space on, or usage of one or more of the transportation modalities for the user. For example, the request for a transportation service can include at least an aerial transport of the user. In response, the cloud service computing system 102 can determine an aerial service provider to provide the aerial transport for the user (e.g., book a seat on an aircraft of the aerial service provider).

For example, in response to a user's request, the cloud services computing system 102 can utilize the one or more algorithms/machine-leamed models to generate a multi-modal transportation itinerary for the user. As an example, in some implementations, the cloud service computing system 102 can sequentially analyze and identify potential transportation legs for each different available transportation modality. For example, a most critical, challenging, and/or supply-constrained transportation leg can be identified first and then the remainder of the multi-modal transportation itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first, etc.). By way of example, the cloud service computing system 102 can assign the user to an aircraft for the middle leg of a three-leg multi-modal itinerary and, then, book a human-driven or autonomous ground-based vehicle for a first leg of the multi-modal itinerary to take the user(s) from an origin location to a first aerial transport facility (e.g., to board the aircraft such as, for example, at an origin facility, etc.). At a later time (e.g., while the user(s) are in flight, etc.), the cloud service computing system 102 can book another human-driven or autonomous ground-based vehicle to take the user(s) from a second aerial transport facility (e.g., a destination facility, etc.) to the specified destination location(s).

In this manner, the cloud service computing system 102 can generate a multi-modal transportation itinerary for facilitating the aerial transportation of the multi-modal transportation service. The multi-modal transportation itinerary can include at least a first transportation leg, a second transportation leg, and a third transportation leg. An aerial service provider, for example, can be associated with the second transportation leg to provide the aerial transport to the user during the second transportation leg from a first aerial transport facility to a second aerial transport facility.

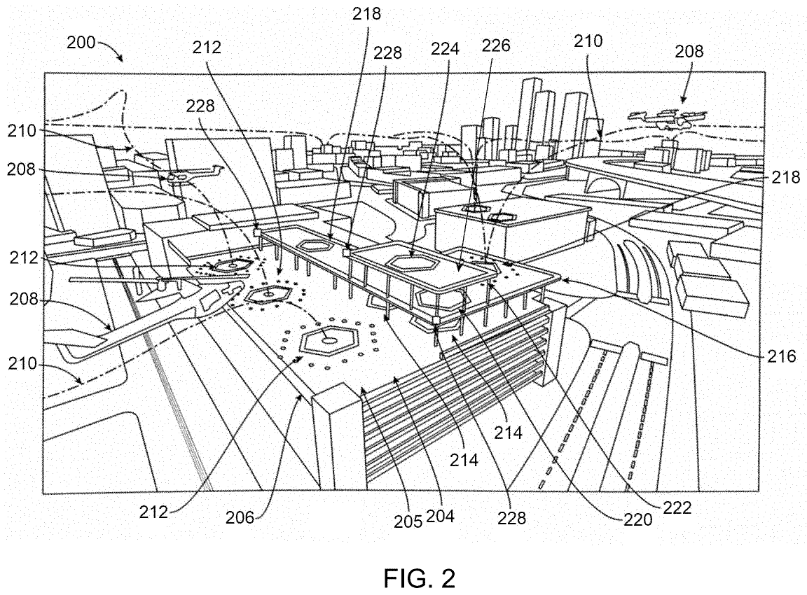

Referring now to FIG. 2, an aerial transport facility 200 is provided according to aspects of the present disclosure. Aerial vehicles can land, park, take-off from, be stored at, etc. a portion of the aerial facility that is ground-level, below ground-level, and/or above ground-level. For example, the aerial transport facility 200 can be located on a roof 204 of a building 206 (e.g., skyscraper, parking garage etc.). In some implementations, aerial vehicles can land, park, take-off from, etc. a portion of the aerial facility that is ground-level or the aerial transport facility 200 can provide landing and/or take-off locations for one or more aerial vehicles 208 (e.g., vertical take-off and landing (VTOL) aerial vehicles) of a multi-modal transportation service.

The aerial transport facility 200 can include a lower level 205, which can include the roof 204 of the building 206 and/or a platform supported on the roof 204 of the building 206. The lower level 205 can include a lower landing area including one or more landing pads 212 and a storage area that includes one or more lower storage locations 214. The aerial transport facility 202 can include an upper level 216 that is supported over at least a portion of the lower level 205. For example, the upper level 216 can be located over one or more of the lower storage locations 214. The upper level 216 can have one or more upper landing pads 218 within an upper landing area and one or more storage locations 220 within an upper storage area. An additional level 222 can be arranged over the storage location(s) 220 of the upper level 216. The additional level 222 can include an emergency landing pad 224 within an emergency landing area 226. However, it should be understood that, in some embodiments, the aerial transport facility 202 can be free of any additional levels above the upper level 216.

A computing system such as, for example, the computing system 100, the cloud service computing system 102, the facility computing devices 152, etc. as described with reference to FIG. 1, can be configured to control, route, monitor, and/or communicate with aircraft in the vicinity of the aerial transport facility 202, for example as described herein. The computing system can be configured to determine or aid in determining respective routes 210 for the aerial vehicle 208 for landing on the aerial transport facility 202 and/or taking-off from the aerial transport facility 200. The computing system can determine a respective landing pad on which the aerial vehicle 208 can land.

In some embodiments, one or more sensors 228 can be configured to detect a location of the aerial vehicle 208 relative to the landing pad (e.g., during approach, landing, taxing, or storage). For example, a portion of the computing system (e.g., facility computing devices 152 located at the aerial transport facility 200) can be operatively connected with the sensor(s) 228 and configured to detect the presence and/or location of the aerial vehicle 208 within the landing areas, within the storage areas, during approach and/or during takeoff. The sensors 228 can be any suitable type of sensor including optical, infrared, heat, radar, LIDAR, pressure, capacitive, inductive, etc.

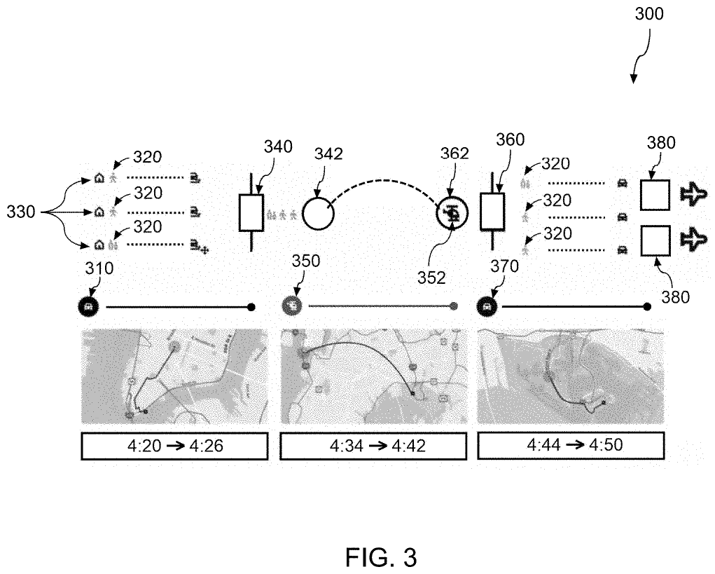

Referring now to FIG. 3, a multi-modal transportation service 300 is depicted according to example embodiments of the present disclosure. As shown, the multi-modal transportation service 300 can include a ground-based transportation service 310 associated with transporting each of a plurality of users 320 from an origin location 330 (e.g., house, office, etc.) to a first aerial transport facility 340. In some implementations, the ground-based transportation service 310 can include an autonomous vehicle. In alternative implementations, the ground-based transportation service 310 can include a human-operated vehicle.

The multi-modal transportation service 300 can include an aerial-based transportation service 350 associated with transporting the plurality of users 320 from the first aerial transport facility 340 to a second aerial transport facility 360. The aerial-based transportation service 350 can include an aerial vehicle 352. The aerial vehicle 352 can land on a rooftop 342 (and/or upper level, ground-level, or below ground-level portion) of the first aerial transport facility 340. In this manner, the plurality of users 320 can board the aerial vehicle 352. When the plurality of users 320 are onboard the aerial vehicle 352, the aerial vehicle 352 can takeoff and fly to the second aerial transport facility 360. More specifically, the aerial vehicle 352 can land on a rooftop 362 (and/or upper level, ground-level, or below ground-level portion) of the second aerial transport facility 360. In this manner, the plurality of users 320 can deboard the aerial vehicle 352.

It should be understood that the aerial vehicle 352 can include any type of vertical takeoff and landing (VTOL) aircraft. For instance, in some implementations, the aerial vehicle 352 can include a helicopter. In alternative implementations, the aerial vehicle 352 can include an autonomous VTOL aircraft. For instance, the autonomous VTOL can be an electric VTOL.

In some implementations, the multi-modal transportation service 300 can include a ground-based transportation service 370 associated with transporting each of the plurality of users 320 to a destination location 380. For instance, in some implementations, the destination location 380 for one or more of the users 320 can include an airport. Alternatively, or additionally, the destination location 380 for one or more of the users 320 can include a residence (e.g., house, apartment, townhouse, etc.). In some implementations, the ground-based transportation service 370 can include an autonomous vehicle. In alternative implementations, the ground-based transportation service 370 can include a human-operated vehicle.

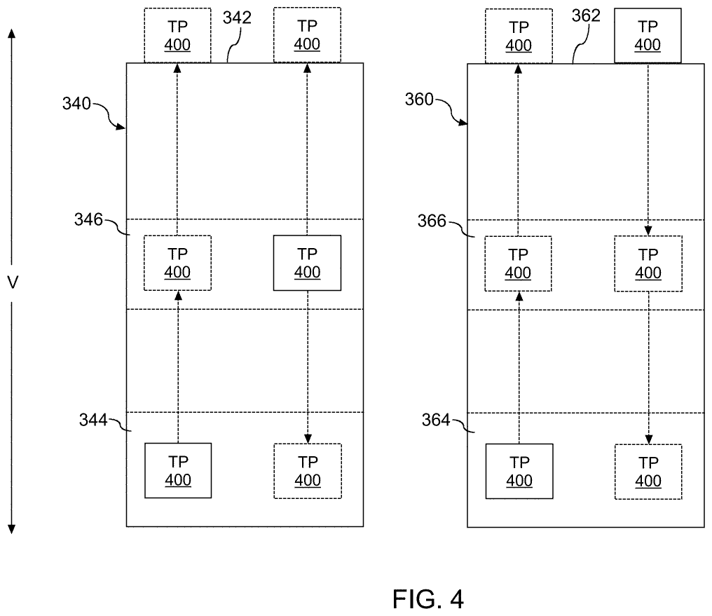

Referring now to FIG. 4, the first aerial transport facility 340 and the second aerial transport facility 360 can include a plurality of transition points. In this example, the first and/or second aerial transport facility 340, 360 can include a plurality of points of egress, a plurality of points of ingress, a plurality of elevators and/or other facility transport mechanisms.

FIG. 4 describes an example embodiment that includes elevators as transition points for illustrative purposes only. As described herein, the technology described herein can include other types of transition points including, for example, other types of facility transport mechanisms.

In the example embodiment, the transition points 400 (e.g., elevators, etc.) at the first aerial transport facility 340 can transport persons from a ground floor 344 to an intermediate floor 346 and/or allow a user to transition from one portion of an aerial facility to another. Likewise, the transition points 400 at the second aerial transport facility 360 can transport persons from a ground floor 364 to an intermediate floor 366. It should be understood that an intermediate floor 346, 366 can include any floor positioned between the ground floor 344, 364 and the rooftop 342, 362. The plurality of transition points 400 can also transport persons to the rooftop 342, 362. For example, the plurality of transition points 400 (e.g., elevators, etc.) can transport persons from the ground floor 344, 364 to the rooftop 342, 362. As another example, the plurality of transition points 400 can transport persons from the intermediate floor 346, 366 to the rooftop 342, 362.

When each of the plurality of users 320 (shown in FIG. 3) of the multi-modal transportation service 300 (shown in FIG. 3) are switching between the ground-based transportation service 310 (FIG. 3) and the aerial-based transportation service 350 (shown in FIG. 3) at the first aerial transport facility 340, the users 320 may utilize one of the transition points 400 to access the rooftop 342. The transition points 400 at the first aerial transport facility 340 can be a chokepoint for the users 320. For example, the transition points 400 (e.g., entrances, elevators, etc.) may experience high congestions levels from users of the multi-model transportation services and/or the transition points 400 may also be used by persons that live or work at the first aerial transport facility 340. For example, instances can occur in which all of the transition points 400 are occupied when one or more of the users 320 of the multi-modal transportation service 300 arrive at the first aerial transport facility 340 to switch between the ground-based transportation service 310 and the aerial-based transportation service 350. In such instances, the one or more users 320 of the multi-modal transportation service 300 must wait until one of the transition points 400 (e.g., elevators, etc.) becomes available. This delay (e.g., waiting, etc.) can represent a choke point associated with switching between the ground-based transportation service 310 service and the aerial-based transportation service 350.

Furthermore, the users 320 (shown in FIG. 3) arriving at the first aerial transport facility 340 may be required to check-in at a check-in station prior to boarding the aerial vehicle 352 (shown in FIG. 3) for the aerial-based transportation service 350 (shown in FIG. 3). In some implementations, the check-in station can be located on the ground floor 344 of the first aerial transport facility 340. In alternative implementations, the check-in station can be located on the intermediate floor 346 of the first aerial transport facility 340. In such implementations, users 320 arriving at the first aerial transport facility 340 must ride one of the transition points 400 (e.g., elevators, etc.) from the ground floor 344 to the intermediate floor 346. It should be understood that the check-in station can be located at any suitable location of the first aerial transport facility 340. For instance, in some implementations, the check-in station can be located on the rooftop 342 of the first aerial transport facility 340.

In some implementations, a transition point (e.g., a check-in station, etc.) can be reserved for the user based on the technology described herein. In some implementations, the computing system can determine constraints based on circumstances associated with the aerial facility and select transition points based on such circumstances. This can include constraining the capacity and/or throughput of a transition point based on the need to reduce the number of users, increase spacing between users, etc.

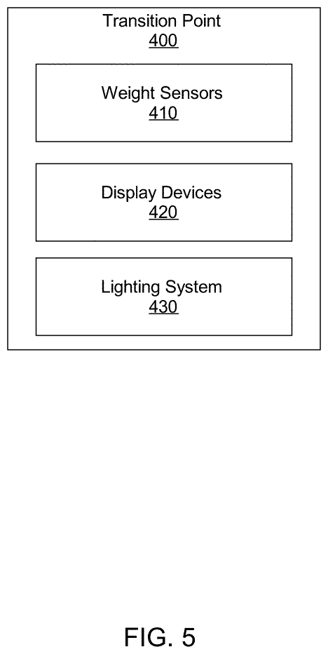

Referring now to FIG. 5, components of one of the transition points 400 are provided according to example embodiments of the present disclosure. As shown, one or more of the transition points 400 can include one or more weight sensors 410 (e.g., load cells). The one or more weight sensors 410 can obtain data indicative of a payload associated with a user of the multi-modal transportation service 300 (shown in FIG. 3). More specifically, the data can be indicative of a weight of the user, the weight of luggage of the user, or both.

In some implementations, one or more of the transition points 400 can include one or more display devices 420 (e.g., screens, televisions, etc.). The one or more display devices 420 can display information to the user. For instance, in some implementations, the information can include a map of the rooftop 342 (shown in FIG. 4) of the first aerial transport facility 340 (shown in FIG. 4). In this manner, the user can become familiar with the layout of the rooftop 342 before exiting the transition points 400 to board the aerial vehicle 352 (shown in FIG. 3). Alternatively, or additionally, the information can include a map of the rooftop 362 (shown in FIG. 4) of the second aerial transport facility 360 (shown in FIG. 4). In this manner, the user can become familiar with the layout of the rooftop 362 of second aerial transport facility 360 before deboarding the aerial vehicle 352.

In some implementations, one or more of the transition points 400 can include an interior lighting system 430. The interior lighting system 430 can include one or more light sources (not shown) configured to illuminate the interior of the transition points, for example, elevators. For instance, when the rooftop of the first aerial transport facility is brightly lit, operation of the interior lighting system 430 for an elevator transporting the user to the rooftop of the first aerial transport facility can be controlled to adjust the intensity (e.g., brightness) of the one or more light sources of the interior light system to adjust the lighting of the interior of the elevator. For example, the lighting in the elevator can be brightened to a determined brightness based on the rooftop brightness when the user enters the elevator. Alternatively, the lighting in the elevator can start at a dimmer interior lighting level and be brightened gradually after a user enters the elevator (e.g., throughout the user riding the elevator) such that the interior lighting level reaches the determined brightness based on the rooftop brightness prior to the user exiting the elevator. Specifically, when the user enters the elevator, the interior lighting for the elevator can start at a determined brightness level based on the brightness of the elevator entrance. As another example, if the rooftop of the first aerial transport facility is dimly lit, the one or more control signals can be associated with dimming the interior lighting for the elevator. For example, the lighting in the elevator can be dimmed to a determined brightness based on the rooftop brightness when the user enters the elevator. Alternatively, the lighting in the elevator can start at a brighter interior lighting level and be dimmed gradually after a user enters the elevator (e.g., throughout the user riding the elevator) such that the interior lighting level reaches the determined brightness based on the rooftop brightness prior to the user exiting the elevator. Specifically, when the user enters the elevator, the interior lighting for the elevator can start at a determined brightness level based on the brightness of the elevator entrance. In this manner, the user's eye can become acclimated to the interior lighting while riding the selected elevator and can therefore be less likely to be affected by the rooftop lighting of the first aerial transport facility. For instance, if the interior of the selected elevator were dimly lit, the user could be slower to exit the selected elevator at the rooftop, because the user's eyes would need time to adjust to the lit at a substantially different level rooftop of the first aerial transport facility. In some implementations, one or more other visual characteristics of the light sources can be adjusted. For example, a color and/or pattern of light emission can be adjusted to indicate which elevator a rider is to use (e.g., the selected elevator as further described herein).

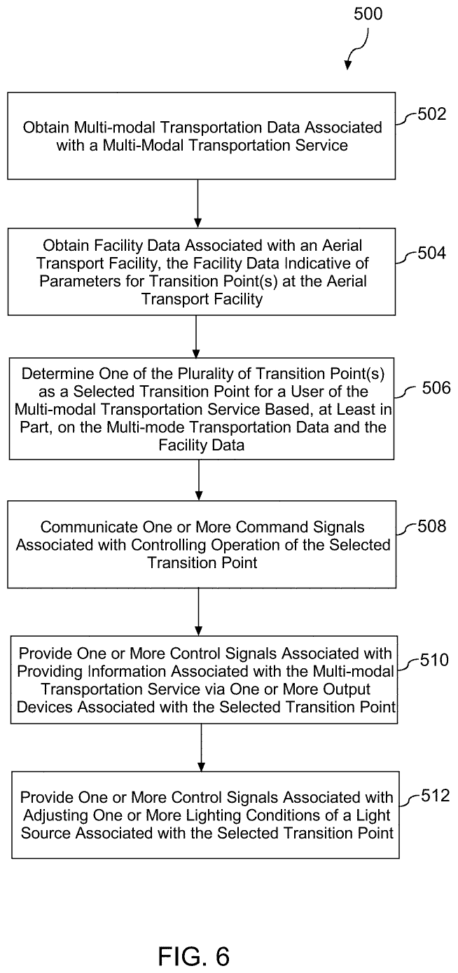

Referring now to FIG. 6, a flowchart diagram of an example method 500 of selecting an elevator at an aerial transport facility for a user of a multi-modal transportation service is provided according to example embodiments of the present disclosure. One or more portion(s) of the method 500 can be implemented by a computing system that includes one or more computing devices such as, for example, the computing systems described with reference to the other figures (e.g., the cloud service computing system 102, facility computing device(s) 152, etc.). Each respective portion of the method 500 can be performed by any (or any combination) of one or more computing devices.

FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 6 is described with reference to elements/terms described with respect to other systems and figures for exemplary illustrated purposes and is not meant to be limiting. One or more portions of method 500 can be performed additionally, or alternatively, by other systems.

At (502), the method 500 can include obtaining, by a computing system, multi-modal transportation data associated with a multi-modal transportation service. The computing system can include, for instance, one or more of the systems/devices of the computing system 100 (e.g., the cloud service computing system 102, the facility computing device(s) 152, etc.) The multi-modal transportation data can include user data indicative of a multi-modal transportation itinerary for the user. The multi-modal transportation itinerary can include at least a first leg and a second leg. The first leg can include a ground-based vehicle service associated with transporting the user from an origin location (e.g., home, office, etc.) to a first aerial transport facility. The second leg can include an aerial-based vehicle service associated with transporting the user from the first aerial transport facility to a second aerial transport facility. In some implementations, the multi-modal transportation itinerary can include a third leg associated with transporting the user from the second aerial transport facility to a destination location (e.g., airport, etc.).

In some implementations, the multi-modal transportation data can include historical data associated with the user of the multi-modal transportation service. For instance, the historical data can be indicative of a weight of luggage the user took with them on previous flights (e.g., second leg of multi-modal transportation itinerary, etc.). Alternatively, or additionally, the user data indicative of the multi-modal transportation itinerary can include data indicative of estimated time of arrival for the user at the aerial transport facility.

In some implementations, the multi-modal transportation data can include historical data associated with the aerial transport facility. For instance, the historical data can be indicative of demand for transition point utilization at the aerial transport facility over a given period of time (e.g., day, week, month, year, etc.). In some implementations, the historical data indicative of demand for transition points can include a volume of transition points taken by users of the multi-modal transportation service and/or a total number of transition points utilized by users that live or work at (or otherwise utilize) the aerial transport facility.

At (504), the method 500 can include obtaining, by the computing system, facility data associated with an aerial transport facility. For instance, the facility data can be indicative of parameters for each of a plurality of transition points at the aerial transport facility. In some implementations, The parameters can be indicative of, for example, (i) a location of at least one of the plurality of transition points relative to a location for a subsequent transportation leg (e.g., proximity to a pick-up area of an assigned ground-transport vehicle, a boarding area for an assigned aerial vehicle, etc.), (ii) a size of each of the plurality of transition points, (iii) a capacity for each of the plurality of transition points, (iv) a top speed for each of the plurality of transition points, and/or other parameters. Alternatively, or additionally, the parameters can include an amount of time remaining before each of the plurality of transition points (e.g., elevators, etc.) is due for a scheduled maintenance event. In some implementations, the parameters can include whether or not a corresponding transition point of the plurality of transition points includes or is otherwise associated with at least one of weight sensors (e.g., load cells, etc.), display devices (e.g., screens, televisions, etc.), light sources (e.g., lights, etc.), and/or other parameters.

At (506), the method 500 can include determining, by the computing system, one of the plurality of transition points as a selected transition point for the user based, at least in part, on the multi-modal transportation data obtained at (502) and the facility data obtained at (504). By way of example, the multi-modal transportation data can indicate the weight of the payload associated with the user. The facility data can indicate characteristic(s) of the transition points at a particular aerial transport facility such as, for example, the payload capacity and schedule/availability of a transition point. As further described herein, the computing system can determine a selected transition point by evaluating the weight of the payload associated with the user and the payload capacity of any of the transition points that may be available for the user when the user arrives at the aerial transport facility. The computing system can select a transition point that is to be available at the time needed by the user and such that the payload/throughput capacity of the transition point is not exceeded by the user (and/or the user's items) when riding in the transition point (e.g., elevator, etc.).

Additionally, or alternatively, the computing system can determine whether any of transition points at the aerial transport facility are designated for use by users of the multi-modal transportation service. If the computing system determines one or more of the transition points are designated for use by users of the multi-modal transportation service, the computing system can determine whether any of the designated transition points will be available for the user at the time the user is predicted to arrive at the aerial facility and/or need access.

In some implementations, as described herein, the computing system can determine a selected transition point for the user of the multi-modal transportation service based, at least in part, on a timing constraint associated with the user. For instance, the multi-modal transportation data can indicate the user's estimated time of departure for the second leg of the multi-modal transportation itinerary and/or the user's ultimate estimated time of arrival at the destination location. Based on this information and location information for a user device (e.g., smartphone, tablet, etc.) for a user device associated with the user, the computing system can determine that the user is delayed/running behind. In response to determining the user is delayed/running behind, the computing system can utilize the facility data to determine which transition points may be available when the user is expected to arrive at the aerial transport facility and reserve and/or provide access to one of the transition points so that the user is not further delayed at the aerial transport facility. This can help expedite the user along the multi-modal itinerary, while also minimizing the effects on other potential users (e.g., that may be effected by the user's delay, etc.).

In some implementations, the computing system can determine a selected transition point based at least in part on the communication hardware associated with the transition point. For example, the multi-modal transportation data can indicate that the user is not familiar with the aerial transport facility (e.g., the historical user usage data indicates that the user has not been previously located at/utilized the aerial transport facility, etc.). The facility data can indicate that certain transition points at the aerial transport facility include display device(s) (and/or audio output device(s) (e.g., speakers, etc.)) that can be utilized to communicate information to the user. In another example, the computing system can determine a selected transition point to assist an impaired user. For instance, the multi-modal transportation data can include information associated with the user including information within a user's profile. This can indicate that the user requires special assistance (e.g., due to a visual and/or audio impairment, etc.). The computing system can use the facility data to select a transition point that have one or more display devices (e.g., display devices, etc.) and/or audio output device(s) (e.g., speakers, etc.) so that information can be communicated to the user. This information can include instructions for proceeding to the next transportation vehicle, check-in instructions, identifying the appropriate transition point, etc.

At (508), the method 500 can include communicating, by the computing system, one or more command signals associated with controlling operation of the transition point selected at (506). The command signal(s) can include communications that include data associated with the selected transition point. In some implementations, the one or more commands signals can be associated with reserving and/or providing access to the selected transition point at the aerial transport facility to ensure one of the transition points is available when the user arrived at the aerial transport facility. This can occur, for example, in the event the entity that coordinates/manages the multi-modal transportation service also owns/controls/leases/etc. the aerial transport facility. For instance, the one or more commands signals can be communicated to an elevator booking system for the aerial transport facility. The elevator booking system can be configured to reserve one of the plurality of elevators for the user. In this manner, an instance can be avoided in which all the elevators are unavailable when the user arrives at the aerial transport facility.

In some implementations, the one or more command signals can be associated with a request to reserve the transition point at the aerial transport facility to accommodate the demand for transition points associated with users of the multi-modal transportation service. This can occur, for example, in the event the entity that owns/controls the aerial transport facility is different than the entity that coordinates the multi-modal transportation service. If the entity that owns/controls aerial transport facility is unable to accommodate the demand for transition points involving users of the multi-modal transportation service, the entity of multi-modal transportation service can reduce throughput at the aerial transport and increase throughput at neighboring aerial transport facilities.

In another example, the computing system can be configured to communicate one or more control signals associated with controlling one or more lighting conditions of a lighting source associated with a transition point. For example, the computing system can send one or more control signals to activate lighting elements, cause lighting elements to emit a certain color/frequency/other characteristic, emit light from a sign, etc. to indicate and/or indicate a path to the selected transition point (e.g., check-in station, exit, etc.).

In some implementations, the computing system can communicate control signals for a plurality of transition points associated with a plurality of users. This can include indicating a first transition point (and/or a path thereto) for a first user and a second transition point (and/or a path thereto) for a second user. For example, a first user device of a first user can obtain a notification that indicates the first user is to utilize a first point of egress (e.g., northwest exit, etc.) that will be indicated by a first color (e.g., blue, etc.). The computing system can communicate control signals that cause light source(s) associated with the first point of egress to emit the first color of light. This can indicate the location of the first point of egress to the user and/or a path lit in the first color for the first user to follow to the first point of egress. A second user device of a second user can obtain a notification that indicates the second user is to utilize a second point of egress (e.g., southeast exit, etc.) that will be indicated by a second color (e.g., red, etc.). The computing system can communicate control signals that cause light source(s) associated with the second point of egress to emit the second color of light. This can indicate the location of the second point of egress to the user and/or a path lit in the second color for the second user to follow to the first point of egress. As such, the computing system can indicate to multiple users their respective transition points, increasing the efficiency of multiple users moving through the aerial transport facility at concurrent times.

In some implementations, the control signal(s) can be associated with providing access to a transition point. For instance, the control signals can unlock a selected point of ingress (e.g., entrance door, gate, etc.) and/or a selected point of egress (e.g., exit door, etc.) for the user. In some implementations, access to a transition point can include communicating data to a user device of a user. For instance, the computing system can provide data indicative of access information (e.g., access code, QR code, etc.) to a user device. Corresponding information (e.g., matching access codes, etc.) can be provided to an access control system associated with the transition point. The access information of the user device can be used with the access control system (e.g., to scan the QR code, etc.) to provide the user access via the transition point. Selection and/or access to a transition point can also, or alternatively, be based on whether a use is able-bodied, as described herein, to help better facilitate the travel of such a user.

At (510), the method 500 can include providing information associated with the multi-modal transportation service. In some implementations, the information associated with the multi-modal transportation service can be provided to a user device (e.g., smartphone, tablet, etc.) associated with the user. The information can be provided to the user device based, at least in part, on the location of the user. For instance, when location data (e.g., GPS data, etc.) for the user device indicates the user is arriving at the first aerial transport facility, the computing system can communicate information to the user device that is indicative of a map of the first aerial transport facility. More specifically, the information can indicate where the elevators are located on the ground floor of the aerial transport facility.

In some implementations, the computing system can provide the user device with other types of data. For example, the computing system can provide data indicative of the transition point, a path thereto, and/or a location of the transition point (e.g., within the map interface, etc.). In some implementations, the data can include a virtual realty or augmented realty interface that can be used to lead the user to the transition point.

In some implementations, the computing system can be configured to determine whether the user is in and/or nearby (e.g., within a threshold distance of 1, 5, 10 ft, etc.) of the selected transition point. For instance, the computing system can obtain location data (e.g., global positioning system data, etc.) from a user device (e.g., smartphone, tablet, etc.) associated with the user. When the location data indicates that the user is associated with the wrong transition point (e.g., that is, not the selected elevator for the user, etc.) at the aerial transport facility, the computing system can provide one or more notifications to the user device. More specifically, the one or more notifications can inform the user that he or she is associated with the wrong transition point and, in some implementations, can provide directions to the selected transition point for the user. Furthermore, in some implementations, the computing system can provide the one or more notifications to one or more display devices (e.g., display screens, etc.) of the wrong transition point in which the user is currently located. The display device(s) can be configured to display the information via a user interface on the display device. Alternatively, or additionally, the computing system can provide one or more commands signals associated with holding the selected transition point for the user since the user is in close proximity (e.g., at the aerial transport facility, etc.) to the selected transition point.

When the location data associated with the user device indicates the user is within the selected transition point, the computing system can, in some implementations, provide information to the user device that is indicative of a map of the rooftop and/or another portion of the first aerial transport facility (e.g., where the user may check-in, board, purchase food, etc.). In this manner, the user can become familiar with the layout of the rooftop (and/or other relevant portion) before entering or exiting the transition point. Furthermore, when the location data associated with the user device indicates the user is departing from the first aerial transport facility, the computing system can communicate information indicative of a layout of the rooftop (and/or another portion) of the second aerial transport facility. In this manner, the user can become familiar with the layout of the rooftop (and/or another portion) at the second aerial transport facility before deboarding the aerial vehicle.

When the location data associated with the user device indicates the user is within an/or with a distance of a transition point at the second aerial transport facility, the computing system can, in some implementations, be configured to communicate information associated with a third leg of the multi-modal transportation itinerary for the user. For instance, the information can include details (e.g., driver name, make of vehicle, model of car, license plate number, parking/pick-up areas, etc.) about the ground-based transportation service associated with the third leg of the multi-modal transportation itinerary.

In some implementations, the information associated with the multi-modal transportation service can be provided to the user via one or more display devices located within an interior of the selected transition point. For instance, the information can include, for instance, frequently asked questions associated with the multi-modal transportation service. In this manner, the information displayed on the one or more display devices can improve the user's experience of the multi-modal transportation service.

At (512), the method 500 can include providing one or more control signals associated with adjusting a lighting condition (e.g., brightness, etc.) and/or other parameters of light emitted from one or more light sources of the selected transition point. For instance, if the rooftop (and/or another portion) of the first aerial transport facility is brightly lit, the one or more control signals can be associated with increasing the intensity of light emitting from the one or more light sources of the interior lighting system for a selected elevator. In this manner, the user's eye can become acclimated to the bright interior lighting while riding the selected elevator to the rooftop (and/or another portion) of the aerial transport facility and can therefore be less likely to be affected by the brightly lit rooftop (and/or another portion). In some implementations, one or more other characteristics associated with the lighting elements can be adjusted based at least in part on the selected elevator. For example, the lighting system for the selected elevator can be instructed to emit light of a certain color or at a certain frequency (e.g., to indicate the selected elevator to the user, to indicate which elevators are not selected, to indicate the selected point of ingress/egress, etc.). In some implementations, an audio system associated with the elevator can be instructed to output a sound (e.g., to indicate the selected elevator to the user, to indicate which elevators are not selected, etc.). In some implementations, the computing system can communicate control signals for a plurality of transition points based on a plurality of users, as described herein.

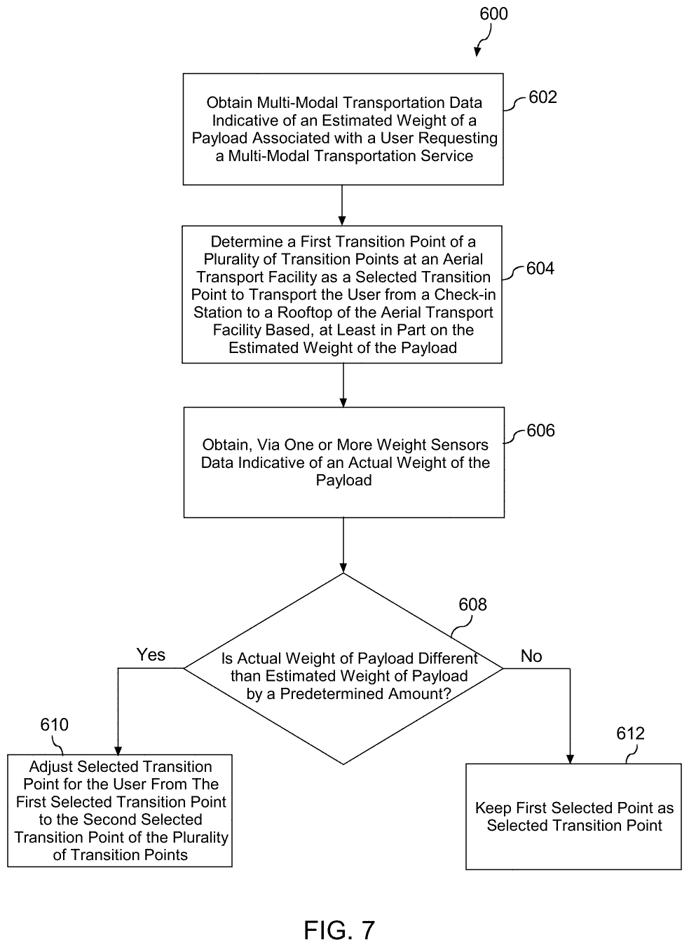

Referring now to FIG. 7, a flowchart diagram of an example method 600 of selecting an elevator at an aerial transport facility for a user of a multi-modal transportation service is provided according to example embodiments of the present disclosure. One or more portion(s) of the method 600 can be implemented by a computing system that includes one or more computing devices such as, for example, the computing systems described with reference to the other figures (e.g., the cloud service computing system 102, facility computing device(s) 152, etc.). Each respective portion of the method 600 can be performed by any (or any combination) of one or more computing devices.

FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 7 is described with reference to elements/terms described with respect to other systems and figures for exemplary illustrated purposes and is not meant to be limiting. One or more portions of method 600 can be performed additionally, or alternatively, by other systems.

At (602), the method 600 can include obtaining multi-modal transportation data indicative of an estimated weight of a payload associated with a user requesting the multi-modal transportation service. In some implementations, the user can provide the estimated weight of the payload via an application running on a device (e.g., smartphone, laptop, tablet, etc.) associated with the user. In alternative implementations, the user can provide the estimated weight of the payload via one or more input devices (e.g., touchscreens, etc.) associated with a point of ingress (e.g., check-in station, etc.) at the aerial transport facility. In some implementations, the payload may be associated with a user other than the one that requested the service (e.g., an accompanying rider, a rider for which the service was requested on the rider's behalf, etc.).

At (604), the method 600 can include determining a first transition point of a plurality of transition points at an aerial transport facility as a selected transition point to transport the user from a check-in station to a rooftop (and/or other portion associated with aerial transport loading/unloading) of the aerial transport facility based, at least in part, in on the multi-modal transportation data obtained at (602) and indicative of the estimated weight of the payload associated with the user. For example, as described herein, the multi-modal transportation data can be indicative of the estimated weight of a payload. The computing system can initially select the first transition point based on the facility data indicating that the first transition point is physically capable of supporting the weight of the payload associated with the user and the first transition point would be available to do so (e.g., not located on another floor, have occupancy for the user/items, etc.).

At (606), the method 600 can include obtaining data indicative of an actual weight of the payload associated with the user via one or more weight sensors of a transition point transporting the user from a ground floor of the aerial transport facility to an intermediate floor on which the check-in station is located. In some implementations, the one or more weight sensors can include one or more load cells. It should be understood that the weight sensors can include any sensor configured to obtain data indicative of the actual weight of the payload associated with the user. In some implementations, the actual weight of the payload can be measured before the user (and/or accompanying items) enter/exit the transition point (e.g., elevator, etc.).

At (608), the method 600 can include determining whether actual weight of the payload obtained at (606) differs from the estimated weight of the payload obtained at (602) by a predetermined amount (e.g., about 30 pounds, about 15 pounds, about 10 pounds, about 5 pounds, etc.). When the computing system determines the actual weight of the payload differs from the estimated weight of the payload by the predetermined amount, the method 600 proceeds to (610). Otherwise, the method 600 proceeds to (612) and the computing system keeps the first selected transition point (e.g., first elevator, etc.) as the selected transition point for the user.

At (610), the method 600 can include adjusting the selected transition point for the user from the first transition point to a second transition point of the plurality of transition points at the aerial transport facility. The size/capacity of the second transition point (e.g., elevator, exit passageway, etc.) can be larger than the size of the first transition point. In this manner, the second transition point can accommodate the payload associated with the user more comfortably than the first transition point.

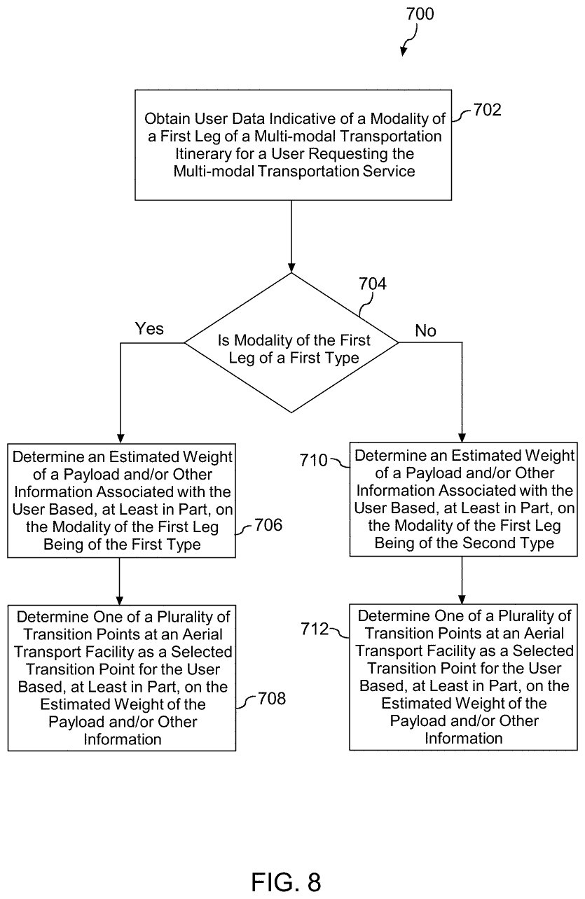

Referring now to FIG. 8, a flowchart diagram of an example method 700 of selecting a transition point at an aerial transport facility for a user of a multi-modal transportation service is provided according to example embodiments of the present disclosure. One or more portion(s) of the method 700 can be implemented by a computing system that includes one or more computing devices such as, for example, the computing systems described with reference to the other figures (e.g., the cloud service computing system 102, facility computing device(s) 152, etc.). Each respective portion of the method 700 can be performed by any (or any combination) of one or more computing devices.

FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to elements/terms described with respect to other systems and figures for exemplary illustrated purposes and is not meant to be limiting. One or more portions of method 700 can be performed additionally, or alternatively, by other systems.

At (702), the method 700 can include obtaining multi-modal transportation data associated with a multi-modal transportation service. The multi-modal transportation data can include user data indicative of a multi-modal transportation itinerary for the user. For instance, the user data can be indicative of a transportation modality of a ground-based transportation service associated with a first leg of the multi-modal transportation itinerary.

At (704), the method 700 can include determining whether the transportation modality associated with the ground-based transportation service is of a first type or a second type. The first type of transportation modality can include ground-based transportation vehicles (e.g., automobiles, etc.) having space to accommodate luggage associated with the user, other persons traveling with the user, or both. Conversely, the second type of transportation modality can include ground-based transportation vehicles (e.g., bicycle, scooter, etc.) lacking space to accommodate luggage associated with the user and other persons traveling with the user.

At (706), the method 700 can include determining whether the transportation modality of the first leg of the multi-modal transportation itinerary is of the first type. When the computing system determines the transportation modality of the first leg is of the first type, the method 700 proceeds to (706). Otherwise, the computing system determines the transportation modality of the first leg is of the second type, and the method 700 proceeds to (710).

At (706), the method 700 can include determining an estimated weight of a payload and/or other information associated with the user based, at least in part, on the transportation modality of the ground-based vehicle associated with the first leg being of the first type. For instance, the computing system can determine the user has luggage since the transportation modality of the ground-based vehicle for the first leg is of the first type, which includes vehicle having space to accommodate luggage and other persons traveling with the user.

At (708), the method 700 can include determining one of the plurality of transition points as a selected transition point for the user based, at least in part, on the estimated weight of the payload and/or other information associated with the user. For instance, since the computing system determined the user may be bringing luggage at (706), the computing system can select one of the larger transition points (e.g., elevators, etc.). In this manner, the selected can accommodate the user and any luggage associated with the user.

At (710), the method 700 can include determining an estimated weight of a payload and/or other information associated with the user based, at least in part, on the transportation modality of the ground-based vehicle associated with the first leg being of the second type. For instance, the computing system can determine the user has no luggage (or is likely to have no luggage) since the transportation modality of the ground-based vehicle for the first leg is of the second type, which includes vehicle lacking space to accommodate luggage and other persons traveling with the user.

At (712), the method 700 can include determining one of the plurality of transition points as a selected transition point for the user based, at least in part, on the estimated weight of the payload and/or other information associated with the user. For instance, since the computing system determined the user is not bringing luggage at (710), the computing system can select one of the smaller elevators. In this manner, instances can be avoided in which a larger transition point (e.g., elevator, etc.) is selected for a user having no luggage and co-passengers.

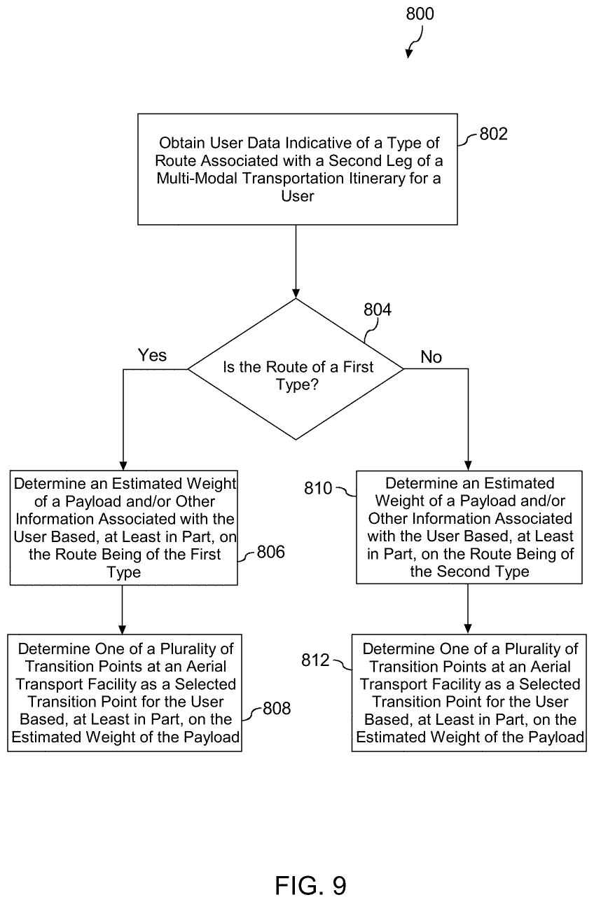

Referring now to FIG. 9, a flowchart diagram of an example method 800 of selecting an elevator at an aerial transport facility for a user of a multi-modal transportation service is provided according to example embodiments of the present disclosure. One or more portion(s) of the method 800 can be implemented by a computing system that includes one or more computing devices such as, for example, the computing systems described with reference to the other figures (e.g., the cloud service computing system 102). Each respective portion of the method 800 can be performed by any (or any combination) of one or more computing devices.

FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 9 is described with reference to elements/terms described with respect to other systems and figures for exemplary illustrated purposes and is not meant to be limiting. One or more portions of method 700 can be performed additionally, or alternatively, by other systems.

At (802), the method 800 can include obtaining multi-modal transportation data associated with a multi-modal transportation service. The multi-modal transportation data can include user data indicative of a multi-modal transportation itinerary for the user. For instance, the user data can be indicative of a type of route associated with a second leg of the multi-modal transportation itinerary.

At (804), the method 800 can include determining whether the type of route associated with the second leg of the multi-modal transportation itinerary is of a first type or a second type. The first type of route can correspond to routes in which the user would bring luggage. For example, when the second aerial transport facility to which the user is traveling via the aerial-based transportation service is located at or near an airport, the route can be of the first type in which the user would bring luggage. Conversely, the second type of route can correspond to routes in which the user would not bring luggage. For example, when the second aerial transport facility to which the user is traveling via the aerial-based transportation service is located at or near an entertainment venue (e.g., a concert hall, etc.), the route can be of the second type in which the user may be less likely to bring substantial luggage. When the computing system determines that the route the user is traveling via the aerial-based transportation is of the first type, the method 800 proceeds to (806). Otherwise, the computing system determines the route is of the second type, and the method 800 proceeds to (810).

At (806), the method 800 can include determining an estimated weight of a payload and/or other information associated with the user based, at least in part, on the route associated with the second leg of the multi-modal transportation itinerary being of the first type. For instance, the computing system can determine the user has luggage since the computing system has classified the route as being of the first type (e.g., routes in which users would bring luggage). This can include, for example, a route to the user's ultimate destination such as an airport.

At (808), the method 800 can include determining one of the plurality of transition points (e.g., elevators, etc.) as a selected transition point (e.g., elevator, etc.) for the user based, at least in part, on the estimated weight of the payload and/or other information associated with the user. For instance, since the computing system determined the user may be bringing luggage at (806), the computing system can select one of the larger transition points (e.g., point of egress with higher throughput capacity, larger elevator, etc.). In this manner, the selected can accommodate the user and any luggage associated with the user.

At (810), the method 700 can include determining an estimated weight of a payload and/or other information associated with the user based, at least in part, on the route associated with the second leg of the multi-modal transportation itinerary being of the second type. For instance, the computing system can determine the user has no luggage/is less likely to have luggage since the computing system has classified the route as being of the second type (e.g., routes in which users would likely not bring luggage, etc.). This can include, for example, a route to the user's ultimate destination such as a concert hall, sporting event, etc.

At (812), the method 800 can include determining one of the plurality of transition points as a selected transition point for the user based, at least in part, on the estimated weight of the payload and/or other information associated with the user. For instance, since the computing system determined the user is not bringing luggage at (810), the computing system can select one of the smaller transition points (e.g., lower capacity point of egress, smaller elevator, etc.). In this manner, instances can be avoided in which a larger transition point is selected for a user having no luggage.

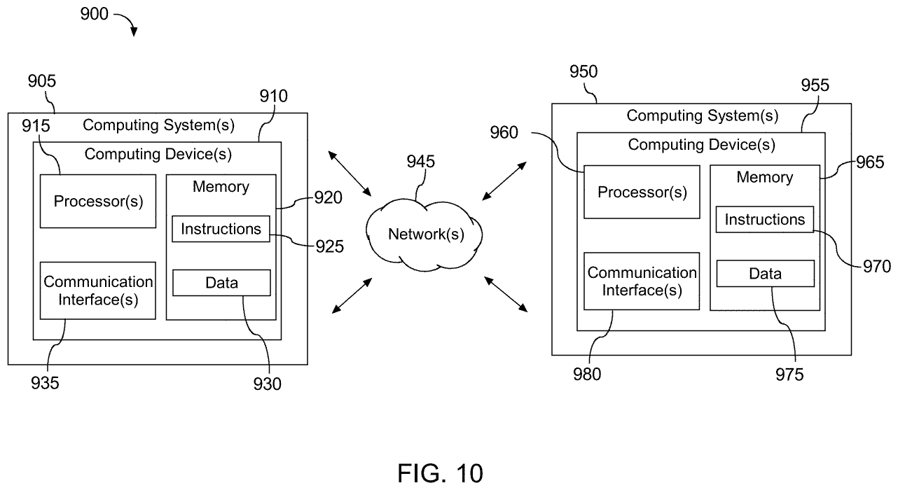

FIG. 10 depicts example system components of an example system 900 according to example embodiments of the present disclosure. The example system 900 can include the computing system 905 (e.g., a cloud service computing system 102) and the computing system(s) 950 (e.g., rider computing device(s) 140, aerial computing device(s) 142, service provider computing device(s) 150, 160, 170, facility computing device(s) 152, vehicle provider computing device(s), 195, etc.) that are communicatively coupled over one or more network(s) 945.

The computing system 905 can include one or more computing device(s) 910. The computing device(s) 910 of the computing system 905 can include processor(s) 915 and a memory 920. The one or more processors 915 can be any suitable processing device (e.g., a processor core, a microprocessor, an ASIC, a FPGA, a controller, a microcontroller, etc.) and can be one processor or a plurality of processors that are operatively connected. The memory 920 can include one or more non-transitory computer-readable storage media, such as RAM, ROM, EEPROM, EPROM, one or more memory devices, flash memory devices, etc., and combinations thereof.

The memory 920 can store information that can be accessed by the one or more processors 915. For instance, the memory 920 (e.g., one or more non-transitory computer-readable storage mediums, memory devices) can include computer-readable instructions 925 that can be executed by the one or more processors 915. The instructions 925 can be software written in any suitable programming language or can be implemented in hardware. Additionally, or alternatively, the instructions 925 can be executed in logically and/or virtually separate threads on processor(s) 1015.

For example, the memory 920 can store computer-readable instructions 925 that, when executed by the one or more processors 915, cause the one or more processors 915 to perform operations such as any of the operations and functions of the cloud service computing system 102, or for which the computing systems) are configured, as described herein.

The memory 920 can store data 930 that can be obtained, received, accessed, written, manipulated, created, and/or stored. The data 930 can include, for instance, facility data and/or other data/information described herein. In some implementations, the computing device(s) 910 can obtain from and/or store data in one or more memory device(s) that are remote from the computing system 905 such as one or more memory devices of the computing system 950.

The computing device(s) 910 can also include a communication interface 935 used to communicate with one or more other system(s) (e.g., computing system 950). The communication interface 935 can include any circuits, components, software, etc. for communicating via one or more networks (e.g., 945). In some implementations, the communication interface 935 can include for example, one or more of a communications controller, receiver, transceiver, transmitter, port, conductors, software and/or hardware for communicating data/information.

The computing system 950 can include one or more computing devices 955. The one or more computing devices 955 can include one or more processors 960 and a memory 965. The one or more processors 960 can be any suitable processing device (e.g., a processor core, a microprocessor, an ASIC, a FPGA, a controller, a microcontroller, etc.) and can be one processor or a plurality of processors that are operatively connected. The memory 965 can include one or more non-transitory computer-readable storage media, such as RAM, ROM, EEPROM, EPROM, one or more memory devices, flash memory devices, etc., and combinations thereof.

The memory 965 can store information that can be accessed by the one or more processors 960. For instance, the memory 965 (e.g., one or more non-transitory computer-readable storage mediums, memory devices) can store the data 975 that can be obtained, received, accessed, written, manipulated, created, and/or stored. The data 975 can include, for instance, facility data, map data, rider data, data associated with transition points, and/or other data or information described herein. In some implementations, the computing system 950 can obtain data from one or more memory device(s) that are remote from the computing system 950.

The memory 965 can also store computer-readable instructions 970 that can be executed by the one or more processors 960. The computer-readable instructions 970 can be software written in any suitable programming language or can be implemented in hardware. Additionally, or alternatively, the computer-readable instructions 970 can be executed in logically and/or virtually separate threads on the one or more processors 960. For example, the memory 965 can store computer-readable instructions 970 that, when executed by the one or more processors 960, cause the one or more processors 960 to perform any of the operations and/or functions described herein, including, for example, any of the operations and functions of the devices described herein, and/or other operations and functions.

The one or more computing devices 955 can also include a communication interface 980 used to communicate with one or more other system(s). The communication interface 980 can include any circuits, components, software, etc. for communicating via one or more networks (e.g., 945). In some implementations, the communication interface 980 can include for example, one or more of a communications controller, receiver, transceiver, transmitter, port, conductors, software and/or hardware for communicating data/information.

The network(s) 945 can be any type of network or combination of networks that allows for communication between devices. In some embodiments, the network(s) 945 can include one or more of a local area network, wide area network, the Internet, secure network, cellular network, mesh network, peer-to-peer communication link and/or some combination thereof and can include any number of wired or wireless links. Communication over the network(s) 945 can be accomplished, for instance, via a network interface using any type of protocol, protection scheme, encoding, format, packaging, etc.

FIG. 10 illustrates one example system 900 that can be used to implement the present disclosure. Other computing systems can be used as well. Computing tasks discussed herein as being performed at a cloud services system can instead be performed remote from the cloud services system (e.g., via aerial computing devices, facility computing devices, etc.), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method comprising:
obtaining, via one or more computing devices of a computing system, multi-modal transportation data associated with a multi-modal transportation service, the multi-modal transportation data comprising user data indicative of a multi-modal itinerary for a user of the multi-modal transportation service;
obtaining, via the one or more computing devices, facility data associated with an aerial transport facility, the facility data indicative of parameters associated with each of a plurality of transition points at the aerial transport facility;
determining, via the one or more computing devices, one of the plurality of transition points as a selected transition point for the user based, at least in part, on the multi-modal transportation data and the facility data; and
communicating, via the one or more computing devices, one or more command signals associated with controlling operation of the selected transition point for the user.

2. The computer-implemented method of claim 1, wherein the plurality of transition points comprises at least one of: (i) a plurality of points of ingress of the aerial facility, (ii) a plurality of points of egress of the aerial facility, or (iii) a plurality of elevators of the aerial transport facility.

3. The computer-implemented method of claim 2, wherein the multi-modal transportation data further comprises user data indicative of an estimated weight of a payload associated with the user.

4. The computer-implemented method of claim 3, wherein the operations further comprise:
obtaining data indicative of an actual weight of the payload associated with the user while the user is located within one of the plurality of elevators.

5. The computer-implemented method of claim 1, wherein the multi-modal itinerary comprises at least a first leg and a second leg, the first leg comprising a ground-based transportation service associated with transporting the user from an origin location to the aerial transport facility, the second leg comprising an aerial-based transportation service associated with transporting the user from the aerial transport facility to another aerial transport facility.

6. The computer-implemented method of claim 5, wherein:
the user data comprises a modality of the ground-based transportation service; and
determining one of the plurality of transition points as the selected transition point for the user comprises:
determining an estimated payload associated with the user based, at least in part, on the modality of the ground-based transportation service; and
determining the selected transition point based, at least in part, on the estimated payload.

7. The computer-implemented method of claim 5, wherein the multi-modal transportation data is indicative of a type of route associated with the second leg of the multi-modal itinerary; and
determining one of the plurality of transition points as the selected transition point for the user comprises:
determining an estimated payload associated with the user based on the type of route associated with the second leg of the multi-modal itinerary; and
determining the selected transition point based, at least in part, on the estimated payload.

8. The computer-implemented method of claim 1, wherein the operations further comprise:
providing information associated with the multi-modal transportation service.

9. The computer-implemented method of claim 8, wherein the information associated with the multi-modal transportation service comprises a map of the aerial transport facility.

10. The computer-implemented method of claim 8, wherein:
the multi-modal transportation itinerary comprises a third leg associated with transporting the user from a second aerial transport facility to a destination location via a ground-based transportation service of the multi-modal transportation service; and
the information associated with the multi-modal transportation service comprises details associated with the third leg of the multi-modal itinerary.

11. The computer-implemented method of claim 1, wherein the multi-modal transportation data further comprises at least one of an estimated time of arrival of the user at a first aerial transport facility or an estimated time of arrival of the user at a destination location.

12. The computer-implemented method of claim 1, wherein the multi-modal transportation data comprises historical data indicative of one or more prior requests for the multi-modal transportation service by the user.

13. The computer-implemented method of claim 12, wherein when the historical data indicates the user has not previously visited the aerial transport facility, determining one of the plurality of transition points as the selected transition point comprises selecting a transition point of the plurality of transition points that includes one or more display devices.

14. The computer-implemented method of claim 1, further comprising:
communicating one or more control signals associated with adjusting one or more lighting conditions of a light source associated with the selected transition point of the aerial transport facility.

15. One or more tangible, non-transitory computer-readable media storing computer-readable instructions that, when executed by one or more processors, cause the one or more processors to perform operations, the operations comprising:
obtaining multi-modal transportation data associated with a multi-modal transportation service, the multi-modal transportation data comprising user data indicative of a multi-modal itinerary for a user of the multi-modal transportation service;
obtaining facility data associated with an aerial transport facility, the facility data indicative of parameters associated with each of a plurality of transition points at the aerial transport facility;
determining one of the plurality of transition points as a selected transition point for the user based, at least in part, on the multi-modal transportation data and the facility data; and
communicating one or more command signals associated with controlling operation of the selected transition point for the user.

16. The one or more tangible, non-transitory computer-readable media of claim 15, wherein the parameters comprise at least one of: (i) a location of at least one of the plurality of transition points relative to a location for a subsequent transportation leg, (ii) a size of each of the plurality of transition points, (iii) a capacity for each of the plurality of transition points, or (iv) a top speed for each of the plurality of transition points.

17. The one or more tangible, non-transitory computer-readable media of claim 15 wherein:
the multi-modal transportation data comprises location data indicative of a user device associated with the user; and
when the location data indicates the user device is located in or at a transition point other than the selected transition point, the operations further comprise:
providing one or more notifications to prompt the user to move to the selected transition point.

18. The one or more tangible, non-transitory computer-readable media of claim 15, wherein the one or more command signals are associated with making the selected transition point accessible.

19. The one or more tangible, non-transitory computer-readable media of claim 15, wherein the one or more command signals are associated with a request to reserve the selected transition point of the plurality of transition points.

20. A computing system comprising:
one or more processors; and
one or more tangible, non-transitory computer-readable media storing computer-readable instructions that, when executed by one or more processors, cause the one or more processors to perform operations, the operations comprising:
obtaining multi-modal transportation data associated with a multi-modal transportation service, the multi-modal transportation data comprising user data indicative of a multi-modal itinerary for a user of the multi-modal transportation service;
obtaining facility data associated with an aerial transport facility, the facility data indicative of parameters associated with each of a plurality of transition points at the aerial transport facility;
determining one of the plurality of transition points as a selected transition point for the user based, at least in part, on the multi-modal transportation data and the facility data; and
communicating one or more command signals associated with controlling operation of the selected transition point for the user.
